(19) United States
(12) Patent Application Publication
(10) Pub. No.: US 2014/0294068 A1
(43) Pub. Date: Oct. 2, 2014

(54) Sample Adaptive Offset Compensation of Video Data

(71) Applicant: Telefonaktiebolaget L M Ericsson (pulb), Stockholm (SE)

(72) Inventors: Kenneth Andersson, Gavle (SE); Rickard Sjöberg, Stockholm (SE); Per Wennersten, Arsta (SE)

(21) Appl. No.: 14/356,499

(22) PCT Filed: Oct. 26, 2012
(86) PCT No.: PCT/SE2012/051166

§ 371 Date: May 6, 2014

Related U.S. Application Data
(60) Provisional application No. 61/556,381, filed on Nov. 7, 2011.
(60) Provisional application No. 61/556,362, filed on Nov. 7, 2011.
(60) Provisional application No. 61/556,938, filed on Nov. 8, 2011.

(51) Int. Cl. H04N 19/132; H04N 19/182; H04N 19/136

(52) U.S. Cl. CPC H04N 19/00127; H04N 19/00139; H04N 19/00303
USPC 375/240.02

(57) ABSTRACT

A method of sample adaptive offset (SAO) compensation of video data is disclosed, where pixels in the video data are classified into SAO categories, each SAO category representing a possible edge artefact and defining a corresponding offset value to be applied to pixels in the respective SAO category to compensate for the edge artefact. In the method, a plurality of SAO categories (200) is provided (110). The plurality of SAO categories includes one or more of the following: a first SAO category (101; 222a; 242a) exclusively representing a first edge artefact where a pixel (224) is at least almost equal to one of its neighbors (226) and distinctly lower than the other neighbor (228) in a given spatial direction, a second SAO category (102; 222b; 242b) exclusively representing a second edge artefact where the pixel (224) is at least almost equal to the other neighbor (228) and distinctly lower than the one neighbor (226) in the given spatial direction, a third SAO category (103; 232a; 252a) exclusively representing a third edge artefact where the pixel is at least almost equal to the one neighbor and distinctly higher than the other neighbor in the given spatial direction, a fourth SAO category (104; 232b; 252b) exclusively representing a fourth edge artefact where the pixel is at least almost equal to the other neighbor and distinctly higher than the one neighbor in the given spatial direction, and a combined SAO category (262, 272) jointly representing either the first and second edge artefacts or the third and fourth edge artefacts in combination, where the pixel is not equal to but close to a first one of the neighbors and distinctly lower or higher than a second one of the neighbors. The method further involves obtaining (120) a block of pixels (114) of video data (112). For pixels in the block of pixels (114), a current pixel is evaluated (130) with respect to its neighbors for a match with any of the SAO categories in the plurality of SAO categories (200). In case of a match (140), the offset value of the matching SAO category is applied (150) for the current pixel.

### TECHNICAL FIELD

Embodiments disclosed herein relate to video processing, and in particular to methods of sample adaptive offset compensation of video data in a video encoder and in a video decoder, respectively. Embodiments disclosed herein also relate to a corresponding video encoder and video decoder, respectively, as well as to associated computer program products, computer readable storage media and user equipments.

### BACKGROUND

Video data needs to be processed in many different situations and applications. A very common kind of processing of video data is encoding and decoding of video data, typically for the purpose of compressing the video data at the source/encoder side by video encoding, and decompressing the encoded video data at the destination/-decoder side by video decoding.

High Efficiency Video Coding (HEVC), also referred to as H.265, is a video compression standard. HEVC is developed jointly by the ISO/IEC Moving Picture Experts Group (MPEG) and ITU-T Video Coding Experts Group (VCEG) as ISO/IEC 23008-2 MPEG-H Part 2 and ITU-T H.HEVC. MPEG and VCEG have established a Joint Collaborative Team on Video Coding (JCT-VC) to develop the HEVC standard.

In a video coding or compression system compliant with, for instance, the HEVC standard, the video data is subjected to various processing steps, including for instance prediction, transformation, quantization, deblocking and adaptive loop filtering. Along the processing path in the video coding or compression system, certain characteristics of the video data may be altered from the original video data due to the operations in the processing steps which the video data is subjected to. For example, artefacts in the form of shifts in image intensity (e.g. chrominance or luminance) may occur for pixels in a video frame, and/or between successive video frames. Such artefacts may be visually noticeable; therefore measures may be taken in order to compensate for the artefacts in an attempt to remove or at least alleviate them.

In HEVC, an intensity compensation scheme known as Sample Adaptive Offset (SAO) is used. The SAO scheme classifies each pixel in the video data into one of multiple SAO categories according to a given context. The context may for instance be the pixel intensity of the video data, which is often referred to as “SAO band offsets”. Alternatively or additionally, the context may be a pixel value relation between the current pixel and its neighboring pixels, which is often referred to as “SAO edge offsets”. In the latter case, the SAO categories represent typical edge artefacts and are associated with respective corresponding offset values to be applied to pixels in the respective SAO category so as to compensate for the edge artefact in question. Depending on where the adaptive offset is applied, the video data may represent reconstructed video data, video data which has undergone deblocking, adaptive loop-filtered video data, or other video data in an intermediate stage during the encoding or decoding process.

More specifically, SAO compensation in HEVC involves four SAO edge offset categories. The first category represents a case where the current pixel (or more specifically its intensity value) is at a local minimum compared to its neighboring two pixels in a selected direction—horizontal (0 degrees), vertical (90 degrees), or diagonal (135 or 45 degrees). The second category represents a case where the current pixel is equal to one of its neighbors but lower than the other neighbor in the selected direction. The third category represents a case where the current pixel is equal to one of its neighbors but higher than the other neighbor in the selected direction. The fourth category represents a case where the current pixel is at a local maximum compared to its neighboring two pixels in the selected direction.

These four SAO categories are shown in FIG. 2a and will be explained in more detail later on in this document. The present inventors have identified certain short-comings with the existing SAO scheme. For instance, the existing set of SAO categories fails to accurately represent some frequently appearing artefacts; hence the SAO compensation is less than optimal.

There is thus a need for improvements in the field of sample adaptive offset (SAO) compensation.

### SUMMARY

After inventive and insightful reasoning, the present inventors have made certain understandings. One such understanding is that a coding efficiency improvement can be obtained by introducing an improved plurality of SAO categories, designed to compensate for other edge artefacts than the ones accounted for in the existing SAO scheme.

A first aspect of embodiments of the present invention therefore is a method of sample adaptive offset (SAO) compensation of video data, wherein pixels in the video data are classified into SAO categories, each SAO category representing a possible edge artefact and defining a corresponding offset value to be applied to pixels in the respective SAO category to compensate for the edge artefact. According to this method, a plurality of SAO categories is provided which includes one or more of the following:
a first SAO category exclusively representing a first edge artefact where a pixel is at least almost equal to one of its neighbors and distinctly lower than the other neighbor in a given spatial direction,
a second SAO category exclusively representing a second edge artefact where the pixel is at least almost equal to said other neighbor and distinctly lower than said one neighbor in the given spatial direction,
a third SAO category exclusively representing a third edge artefact where the pixel is at least almost equal to said one neighbor and distinctly higher than said other neighbor in the given spatial direction,
a fourth SAO category exclusively representing a fourth edge artefact where the pixel is at least almost equal to said other neighbor and distinctly higher than said one neighbor in the given spatial direction, and
a combined SAO category jointly representing either said first and second edge artefacts or said third and fourth edge artefacts in combination, where the pixel is not equal to but close to a first one of the neighbors and distinctly lower or higher than a second one of the neighbors.

Then, the method involves obtaining a block of pixels of video data. For pixels in said block of pixels, a current pixel is evaluated with respect to its neighbors for a match with any of the SAO categories in the plurality of SAO categories, and, in case of a match, the offset value of the matching SAO category is applied for said current pixel.

It is to be noticed herein that “the first/second/third/fourth SAO category exclusively represents the first/second/third/fourth edge artefact” means that the first/second/third/fourth SAO category does not represent any other edge artefact than the respective first/second/third/fourth edge artefact. This allows for a more accurate SAO compensation for the edge artefact in question.

The offset value defined by each SAO category may typically pertain to pixel chrominance or pixel luminance in a color model such as, for instance, YCbCr. Other color models, including but not limited to RGB, are however also possible.

The Detailed Description section will give several examples of advantageous compositions of the plurality of SAO categories according to some preferred embodiments, and also advantageous ways of evaluating the current pixel is with respect to its neigbors and determining the offset value of a matching SAO category. These preferred embodiments offer improved and increased sets of SAO edge offset categories being capable of compensating for broader varieties of edge artefacts and/or more accurate SAO compensation.

The method may for instance be performed upon video data in the form of a reconstructed reference block of pixels for use in prediction of a block of pixel values. Such prediction may, for instance, be inter-frame or intra-frame prediction in a video encoder or video decoder of the type using entropy encoding of transformed and quantised residual error in predicted video data compared to actual video data. Such a video encoder or video decoder may, for instance but not necessarily, be compatible with High Efficiency Video Encoding (HEVC). The method according to the first aspect is therefore equally applicable to an encoder side and a decoder side of a video coding or compression system.

As an alternative to performing the method inside such an encoding loop, the method may be performed as a pre-filter on the video source (i.e. the video data) before encoding for the purpose of removing noise from the video source at the encoder side and improve the video compression efficiency. Additionally or alternatively, the method may be performed separately from the decoding loop in a post-filtering step at the decoder side.

In one embodiment, where the method is performed in a video encoder, said plurality of SAO categories are provided as a second set of SAO categories including more SAO categories than a first set of SAO categories which is also provided and also represents edge artefacts. In the method according to this embodiment, a current set of SAO categories is selected, for the obtained block of pixels, among said first and second sets of SAO categories. The selected current set of SAO categories is used in said steps of evaluating and applying, and in an outgoing encoded video bitstream, an indication of the selected current set of SAO categories is provided, the indication being intended for a video decoder. The indication may, for instance, be given in the form of a flag or other information in the outgoing encoded video bitstream.

Being able to switch between the first and second sets of SAO categories provides for a coding-efficient improvement in video artefact compensation. The first set of SAO categories may contain a small number of categories which reflect the most typical artefacts. The second set of SAO categories may contain a larger number of categories to reflect also other artefacts, and/or a refined representation of the different artefacts. Choosing the first (small) set of SAO categories will hence be coding-efficient since fewer offset values will have to be sent to the decoder side, whereas choosing the second (larger) set of SAO categories will allow improved artefact compensation.

In a corresponding embodiment, where the method is performed in a video decoder, said plurality of SAO categories are provided as a second set of SAO categories including more SAO categories than a first set of SAO categories which is also provided and also represents edge artefacts. In the method according to this corresponding embodiment, an indication of a current set of SAO categories to be selected is determined from an incoming encoded video bitstream, the indication originating from a video encoder. For the obtained block of pixels, the current set of SAO categories is selected among said first and second sets of SAO categories based on the determined indication. The selected current set of SAO categories is then used in said steps of evaluating and applying.

A second aspect of embodiments of the present invention is a computer program product encoded with computer program code means which, when loaded and executed by a processing unit, cause performance of the method according to the first aspect.

A third aspect of embodiments of the present invention is a computer readable storage medium encoded with instructions which, when loaded and executed by a processing unit, cause performance of the method according to the first aspect.

A fourth aspect of embodiments of the present invention is a control device for sample adaptive offset (SAO) compensation of video data, wherein pixels in the video data are classified into SAO categories, each SAO category representing a possible edge artefact and defining a corresponding offset value to be applied to pixels in the respective SAO category to compensate for the edge artefact. The control device is configured to provide a plurality of SAO categories which includes one or more of the following:
a first SAO category exclusively representing a first edge artefact where a pixel is at least almost equal to one of its neighbors and distinctly lower than the other neighbor in a given spatial direction,
a second SAO category exclusively representing a second edge artefact where the pixel is at least almost equal to said other neighbor and distinctly lower than said one neighbor in the given spatial direction,
a third SAO category exclusively representing a third edge artefact where the pixel is at least almost equal to said one neighbor and distinctly higher than said other neighbor in the given spatial direction,
a fourth SAO category exclusively representing a fourth edge artefact where the pixel is at least almost equal to said other neighbor and distinctly higher than said one neighbor in the given spatial direction, and
a combined SAO category jointly representing either said first and second edge artefacts or said third and fourth edge artefacts in combination, where the pixel is not equal to but close to a first one of the neighbors and distinctly lower or higher than a second one of the neighbors.

The control device is further configured to obtain a block of pixels of video data. For pixels in said block of pixels, the control device is further configured to evaluate a current pixel with respect to its neighbors for a match with any of the SAO categories in said plurality of SAO categories, and, in case of a match, apply the offset value of the matching SAO category for said current pixel.

The control device according to the fourth aspect may generally have the same or directly corresponding features as the method according to the first aspect.

A fifth aspect of embodiments of the present invention is a video encoder comprising a control device according to the fourth aspect.

A sixth aspect of embodiments of the present invention is a video decoder comprising a control device according to the fourth aspect.

A seventh aspect of embodiments of the present invention is a user equipment which comprises at least one of a control device according to the fourth aspect, a video encoder according to the fifth aspect, and a video decoder according to the sixth aspect.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated. It should be emphasized that the term “comprises/comprising” when used in this specification is taken to specify the presence of stated features, integers, steps, or components, but does not preclude the presence or addition of one or more other features, integers, steps, components, or groups thereof.

### BRIEF DESCRIPTION OF THE DRAWINGS

Embodiments of the invention will be described in further detail below with reference to the accompanying drawings.

FIG. 1 is a schematic flowchart diagram to illustrate an improved method of sample adaptive offset compensation of video data.

FIG. 2a schematically illustrates an example of a plurality of SAO categories representing edge artefacts according to standard HEVC.

FIG. 2b schematically illustrates an example of a plurality of SAO categories representing edge artefacts according to a first embodiment.

FIG. 2c schematically illustrates an example of a plurality of SAO categories representing edge artefacts according to a second embodiment.

FIG. 2d schematically illustrates an example of a plurality of SAO categories representing edge artefacts according to a third embodiment.

FIG. 2e schematically illustrates an example of a plurality of SAO categories representing edge artefacts according to a fifth embodiment.

FIG. 3 is a schematic block diagram to illustrate a video encoder according to one embodiment, capable of implementing the method shown in FIG. 1.

FIG. 4 is a schematic block diagram to illustrate a video decoder according to one embodiment, capable of implementing the method shown in FIG. 1.

FIG. 5 is a schematic block diagram to illustrate a computer containing a computer program product capable of implementing any of the methods disclosed herein.

FIG. 6 is a schematic block diagram to illustrate a computer readable storage medium containing computer program instructions capable of implementing any of the methods disclosed herein.

FIG. 7a is a schematic block diagram to illustrate a user equipment containing a video decoder which may be the video decoder shown in FIG. 4.

FIG. 7b is a schematic block diagram to illustrate a user equipment containing a video encoder which may be the video encoder shown in FIG. 3.

FIG. 8 is a schematic block diagram to illustrate an embodiment where the video encoder and/or the video decoder are/is implemented in a network device in a communication network.

FIG. 9a is a schematic flowchart diagram to illustrate an improved method of sample adaptive offset compensation of video data according to an alternative embodiment, performed in a video encoder such as the one shown in FIG. 3.

FIG. 9b is a schematic flowchart diagram to illustrate an improved method of sample adaptive offset compensation of video data according to an alternative embodiment, performed in a video decoder such as the one shown in FIG. 4.

### DETAILED DESCRIPTION

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

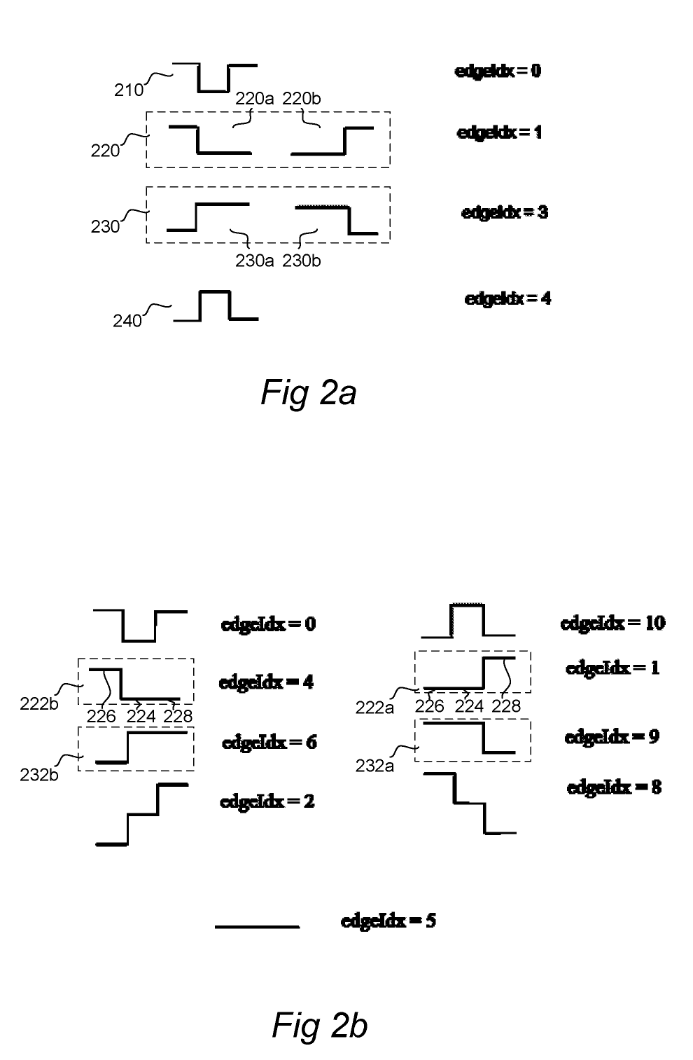

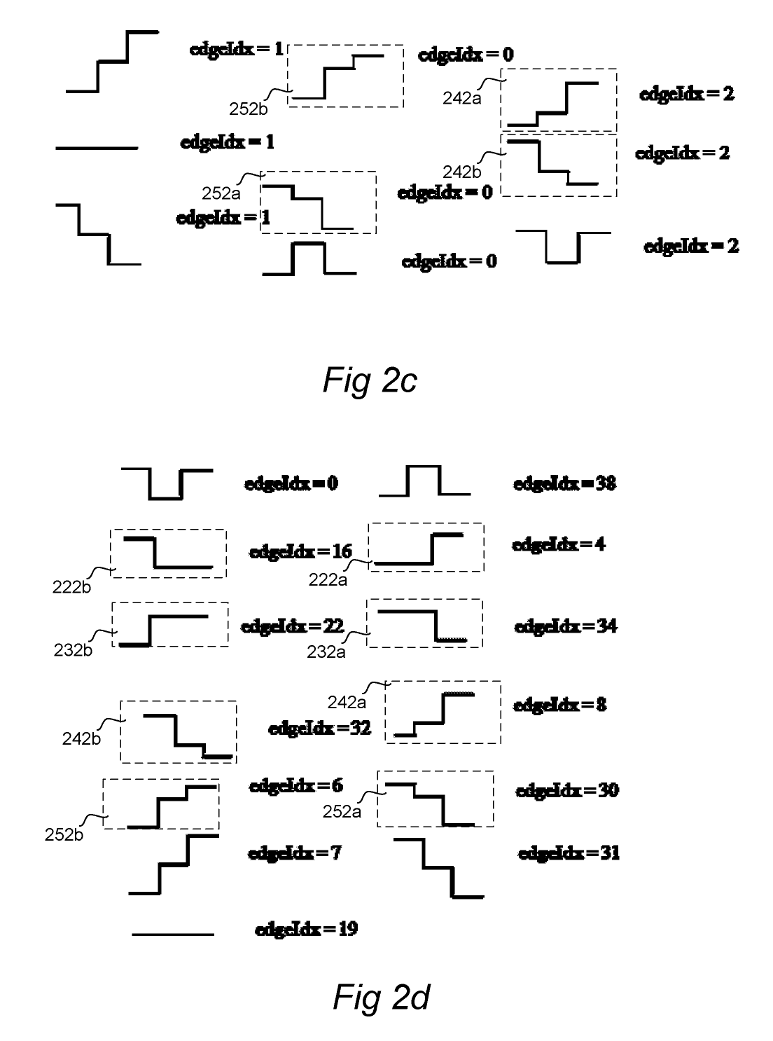

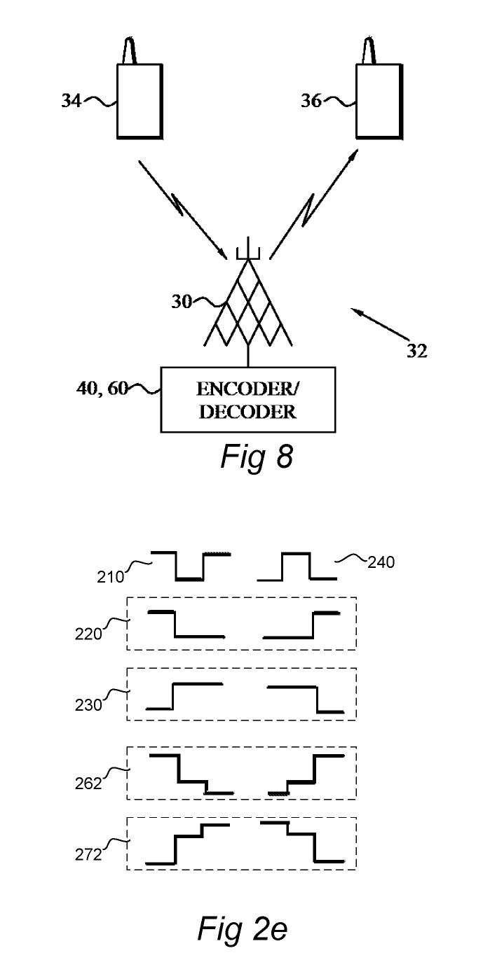

The disposition of this Detailed Description section is as follows. First, the SAO (sample adaptive offset) procedure as such, in standard HEVC, will be briefly explained in Chapter 1 with reference primarily to FIG. 2a.

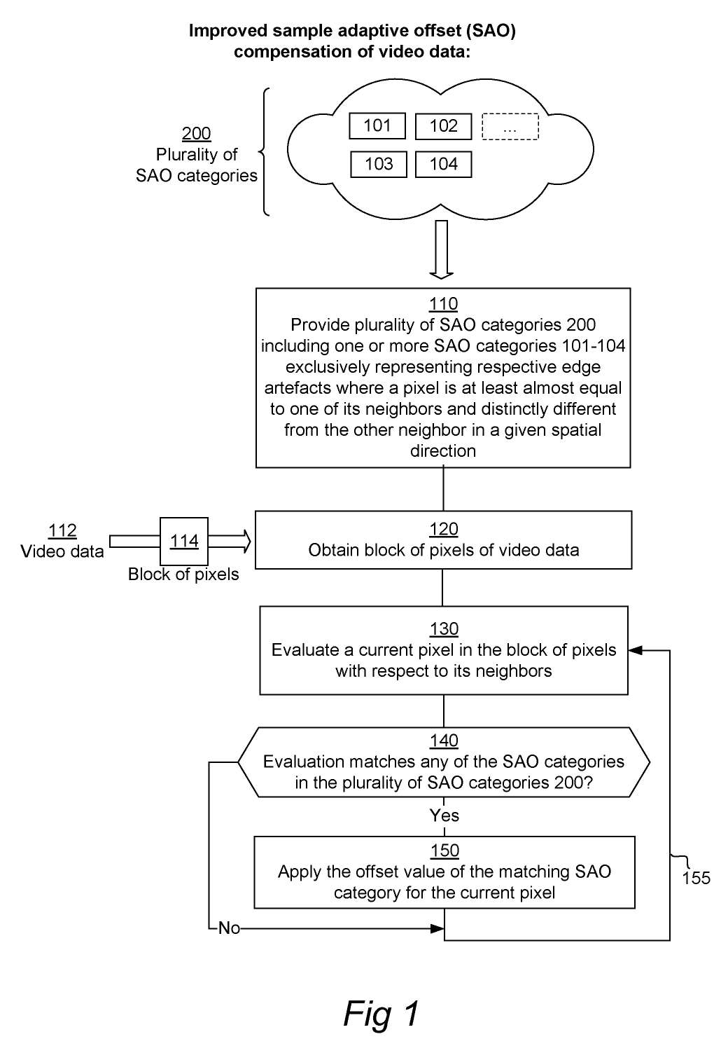

Then, improved SAO compensation of video data based on an improved plurality of SAO categories, designed to compensate for other edge artefacts than the ones accounted for in the existing SAO scheme, will be described in Chapter 2 for the video encoder side and the video decoder side, respectively, with reference primarily to FIGS. 1 and 2a-2e. Some different embodiments will be described in sub-chapters with reference primarily to FIGS. 2b to 2e.

Following this, in Chapter 3 and with reference primarily to FIG. 3 to FIG. 8, corresponding implementations of the improved SAO compensation of video data will be described in the form of a video encoder, a video decoder, etc.

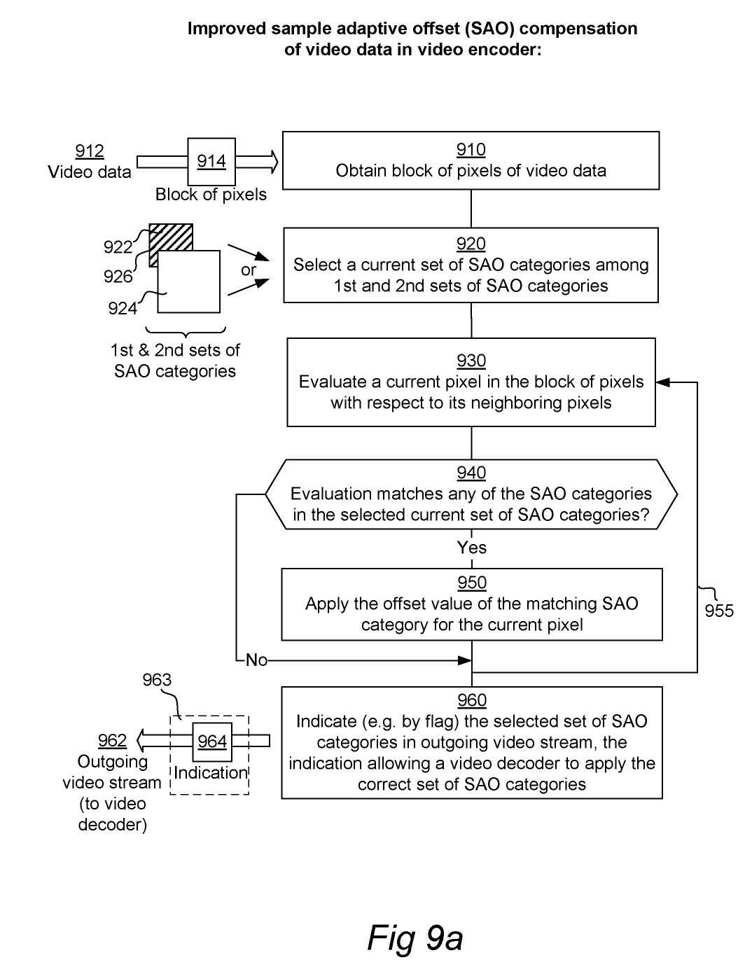

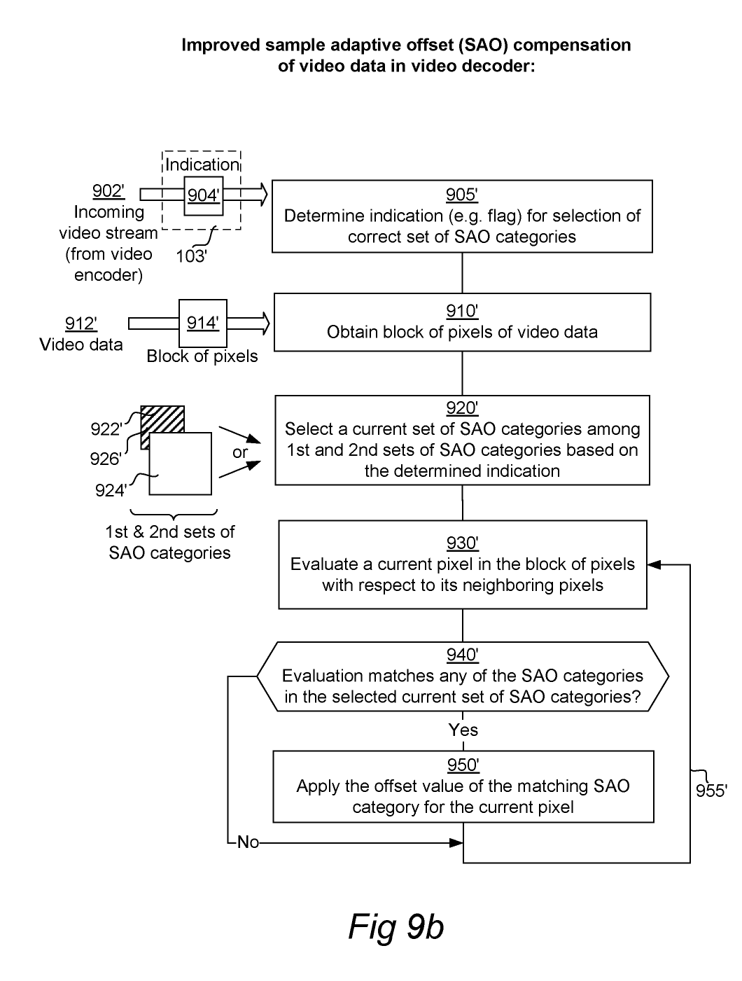

Finally, embodiments based on switching between first and second SAO categories will be described in Chapter 4 for the video encoder side and the video decoder side, respectively, with reference primarily to FIGS. 9a and 9b.

1. The SAO Procedure in HEVC

SAO is used in HEVC after the deblocking filter process (if deblocking is used, otherwise directly after reconstruction of prediction and residual). SAO modifies the picture that is to be displayed or stored in the reference picture buffer.

In HEVC, SAO edge offsets (to compensate for edge artefacts) can be used in one of 4 directions, e.g. horizontal, vertical, diagonal from top left to bottom right, or diagonal from bottom left to top right. The specific direction is determined by saoTypeIdx=1.4. saoTypeIdx=5.6 are used for SAO band offsets (to compensate for band artefacts).

When edge offsets are selected (e.g. sao_type_idx is 1 or 2 or 3 or 4), four offsets are used for specific edge types. These edge types, or edge artefacts, are illustrated in FIG. 2a at 210, 220, 230 and 240, respectively, and will be referred to again further below. The edge types are derived for each pixel by comparing each pixel with its respective neighbors, according to the following formula:

edgeIdx=2+Σₖ Sign(recPicture[xC+i,yC+j]−recPicture[xC+i+hPos[k],yC+j+vPos[k]]) with k=0.1

where recPicture is the picture after deblocking filter process, where xC+i denotes a pixel position in the horizontal direction and yC+j denotes a pixel position in the vertical direction, and hPos and vPos are as defined in the following table:

| sao_type_idx | 1 | 2 | 3 | 4 |
|---|---|---|---|---|
| hPos[0] | −1 | 0 | −1 | 1 |
| hPos[1] | 1 | 0 | 1 | −1 |
| vPos[0] | 0 | −1 | −1 | 1 |
| vPos[1] | 0 | 1 | 1 | −1 |

where saoTypeIdx is equal to sao_type_idx[cIdx][saoDepth][rx][ry], where cIdx denotes a color component for example one of Y (luma), Cb (chroma) or Cr (chroma) components, saoDepth, rx and ry denotes which part of the image that SAO is applied at.

Otherwise, if saoTypeIdx is equal to one of the values 5 or 6 and band offsets are hence selected instead of edge offsets, the following ordered steps apply:

A variable bandShift is set equal to BitDepthY−5 if cIdx is equal to 0, otherwise, set equal to BitDepthC−5, where BitDepthY is the bit depth of the luma component and BitDepthC is the bit depth of the chroma component.

The reconstructed picture buffer is modified as

recSaoPicture[xC+i,yC+j]=recPicture[xC+i,yC+j]+saoValueArray[bandTable[saoTypeIdx−5][bandIdx]]

with i=0 . . . nS-1 and j=0 . . . nS-1, where bandIdx is set equal to (recPicture[xC+i, yC+j]>>bandShift) and bandTable is as specified below:

| | bandIdx | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| bandTable[0][bandIdx] | 0 | 0 | 0 | 0 | 0 | 0 | 0 | 0 | 1 | 2 | 3 | 4 | 5 | 6 | 7 | 8 |
| bandTable[1][bandIdx] | 1 | 2 | 3 | 4 | 5 | 6 | 7 | 8 | 0 | 0 | 0 | 0 | 0 | 0 | 0 | 0 |
| | bandIdx | | | | | | | | | | | | | | | |
| | 16 | 17 | 18 | 19 | 20 | 21 | 22 | 23 | 24 | 25 | 26 | 27 | 28 | 29 | 30 | 31 |
| bandTable[0][bandIdx] | 9 | 10 | 11 | 12 | 13 | 14 | 15 | 16 | 0 | 0 | 0 | 0 | 0 | 0 | 0 | 0 |
| bandTable[1][bandIdx] | 0 | 0 | 0 | 0 | 0 | 0 | 0 | 0 | 9 | 10 | 11 | 12 | 13 | 14 | 15 | 16 |

Otherwise (when sao_type_idx[cIdx][saoDepth][rx][ry] is equal to 0), the following applies:

recSaoPicture[xC+i,yC+j]=recPicture[xC+i,yC+j] with i=0 . . . nS-1 and j=0 . . . nS-1

The reconstructed picture buffer is modified as (this is done separately for each picture, recSaoPicture is the reconstructed picture after SAO, and recPicture is the picture before SAO):

recSaoPicture[xC+i,yC+j]=recPicture[xC+i,yC+j]+saoValueArray[edgeTable[edgeIdx]] with i=0 . . . nS-1 and j=0 . . . nS-1

where edgeTable[5]={1, 2, 0, 3, 4}

saoValueArray is set equal to SaoOffsetVal[cIdx][saoDepth][rx][ry] which is defined below.

sample_adaptive_offset_flag specifies whether sample adaptive offset applies or not for the current picture.

sao_flag_cb equal to 1 denotes sample adaptive offset process for Cb shall be applied to the current picture.

sao_flag_cr equal to 1 denotes sample adaptive offset process for Cr shall be applied to the current picture.

sao_split_flag[cIdx][saoDepth][rx][ry] specifies whether a region is split into four sub regions with half horizontal and vertical number of LCU for the color component cIdx. The array indices rx and ry specify the region index and saoDepth specifies the split depth of the region. When sao_split_flag[cIdx][saoDepth][rx][ry] is not present, it shall be inferred to be equal to 0.

The maximum allowed depth for sample adaptive offset process SaoMaxDepth is derived as follows:

SaoMaxDepth=Min(4,Min(Floor(Log2(PicWidthInLCUs)),Floor(Log2(PicHeightInLCUs)))) (7 10)

where

PicWidthInLCUs=Ceil(PicWidthInSamplesL÷(1<<Log2MaxCUSize))

PicHeightlnLCUs=Ceil(PicHeightlnSamplesL(1<<Log2MaxCUSize))

sao_type_idx[cIdx][saoDepth][rx][ry] indicates the offset type for the color component cIdx of the region specified by saoDepth, rx and ry.

sao_offset[cIdx][saoDepth][rx][ry][i] indicates the offset value of i-th category for the color component cIdx of the region specified by saoDepth, rx and ry.

The variable bitDepth is derived as follows.
If cIdx is equal to 0, bitDepth is set equal to BitDepthY.
Otherwise (cIdx is equal to 1 or 2), bitDepth is set equal to BitDepthC.

The offset value shall be in the range of [−(1<<(SaoBitsRange−1)), (1<<(SaoBitsRange−1))−1] where

SaoBitRange=Min(bitDepth, 10)−4

An array SaoOffsetVal is specified as

$$SaoOffsetVal [ cIdx ] [ saoDepth ] [ rx ] [ ry ] [ 0 ] = 0 \\ SaoOffsetVal \{ cIdx ] [ saoDepth ] [ rx ] [ ry ] [ i + 1 ] = sao\_offset [ cIdx ] [ saoDepth ] [ rx ] [ ry ] [ i ] << ( bitDept h - Min ( bitDepth , 10 ) )$$

$$with i = 0. . NumSaoClass - 1$$

The number of categories, NumSaoClass, is specified below:

| sao_type_idx | NumSaoClass | Artefact type (informative) |
|---|---|---|
| 0 | 0 | Not applied |
| 1 | 4 | Edge in 1D 0-degree direction |
| 2 | 4 | Edge in 1D 90-degree direction |
| 3 | 4 | Edge in 1D 135-degree direction |
| 4 | 4 | Edge in 1D 45-degree direction |
| 5 | 16 | Central band |
| 6 | 16 | Side band |

The SAO syntax is as follows:

sao_param( ) {

| | |
|---|---|
| sample_adaptive_offset_flag | u(1) |
| if ( sample_adaptive_offset_flag ) { | |

| | |
|---|---|
| sao_split_param( 0, 0, 0, 0 ) | |
| sao_offset_param( 0, 0, 0, 0 ) | |
| sao_flag_cb | u(1) \| ae(v) |
| if( sao_flag_cb ) { | |

sao_split_param( 0, 0, 0, 1 )
sao_split_param( 0, 0, 0, 1 )

| | |
|---|---|
| } | |
| sao_flag_cr | u(1) \| ae(v) |
| if( sao_flag_cr ) { | |

sao_split_param( 0, 0, 0, 2 )
sao_split_param( 0, 0, 0, 2 )

}

}

}
sao_split_param( rx, ry, saoDepth , cIdx ) {

if( saoDepth < SaoMaxDepth )

| | |
|---|---|
| sao_split_flag[ cIdx ][ saoDepth ][ | u(1) \| ae(v) |
| rx ][ ry ] | |

Else

sao_split_flag[ cIdx ][ saoDepth ][
rx ][ ry ] = 0

if( sao_split_flag[ cIdx ][ saoDepth ][
rx ][ ry ] ) {

sao_split_param( 2*rx + 0, 2*ry + 0,
saoDepth + 1 , cIdx )
sao_split_param( 2*rx + 1, 2*ry + 0,
saoDepth + 1 , cIdx )
sao_split_param( 2*rx + 0, 2*ry + 1,
saoDepth + 1 , cIdx )
sao_split_param( 2*rx + 1, 2*ry + 1,
saoDepth + 1 , cIdx )

}

}

Thus, when an encoded video frame is reconstructed, the pixels of the video frame are grouped, and different SAO offsets are determined for each group. As already mentioned, one way of grouping pixels is “SAO edge offset”, representing possible edge artefacts. This is achieved by comparing a pixel with its neighboring pixels. This comparison is done in different directions, i.e. the horizontal neighbors of the pixel, the vertical neighbors of the pixel, or the diagonal neighbors of the pixel, are compared with a current pixel. The selected direction for the comparison is reflected by the aforementioned parameter sao_type_idx when having the value 1, 2, 3 or 4.

Based on this comparison, the pixel is categorized into NumSaoClass categories (where NumSaoClass=4 in case of SAO edge offsets), and an offset value is specified for each category, which should be used to modify the reconstructed video frame.

The edge artefacts that HEVC SAO edge offset addresses are shown in FIG. 2a. For edgeIdx=0, as seen at 210, the pixel value of the current (center) pixel is smaller than its neighbors (i.e. a local minimum). For edgeIdx=1, as seen at 220, one neighbor has a larger pixel value and one neighbor has the same pixel value as the current pixel. For edgeIdx=3, as seen at 230, one neighbor has a smaller pixel value and one neighbor has the same pixel value as the current pixel. Finally, for edgeIdx=4, as seen at 240, the pixel value of the current pixel is larger than its neighbors (i.e. a local maximum).

Four offset values are then specified, one for each of these four values of edgeIdx. If the offset value for edgeIdx=0 is +4, for example, then a value of four will be added to each pixel which has a smaller value than each of its neighbors in the chosen direction (as indicated by the parameter sao_type_idx). If edgeIdx is equal to 2, it does not belong to one of these four categories, and no offset is applied.

As already mentioned, sao_type_idx=5 and sao_type_idx=6 are called SAO band offsets and represent band artefacts. Here, specific offset values are assigned to pixels with pixel values within certain ranges. sao_type_idx=5 assigns offsets for all pixels with values from 64 to 191 in groups of eight. For example, pixels with values from 64 to 71 have one offset value, pixels with values from 72 to 79 have another, and so on. sao_type_idx=6 assigns offsets for all pixels with values from 0 to 63, and for all pixels with values from 192 to 255.

2. Improved SAO Compensation of Video Data Based on Improved Plurality of SAO Categories

The standard SAO procedure in HEVC as explained in Chapter 1 above hence uses a small set of SAO categories to represent edge artefacts. More specifically, a set of no more than four (NumSaoClass=4) SAO categories 210-240, referred to as edgeIdx=0, 1, 3 and 4 in FIG. 2a, represents a total of no more than six edge artefacts. Noticeably, two of the SAO categories, 220 and 230, represent two edge artefacts each, marked 220a-b and 230a-b, respectively.

An improvement over the standard SAO procedure in HEVC will now be described with reference primarily to FIGS. 1 and 2a-2e.

FIG. 1 illustrates a method of SAO compensation of video data which may be performed in a video encoder and/or in a video decoder. The video encoder may, for instance, be the video encoder 40 which will be described in more detail later with reference to FIG. 3. The video decoder may, for instance, be the video decoder 60 which will be described in more detail later with reference to FIG. 4. According to the method in FIG. 1, a plurality of SAO categories 200 is provided, as seen in step 110. Each SAO category in the plurality of SAO categories 200 represents a possible edge artefact and defines a corresponding offset value to be applied to pixels in the respective SAO category to compensate for the edge artefact.

The plurality of SAO categories 200 includes one or more novel SAO categories 101-104, the configuration and advantages of which will be described in more detail below. In addition to the one or more novel SAO categories 101-104, the plurality of SAO categories 200 may or may not include also other SAO categories, including one or more of the SAO edge artefact categories from standard HEVC as shown in FIG. 2a, and/or one or more SAO band artefact categories. Such other SAO categories are, however, not central to the present disclosure.

The one or more novel SAO categories 101-104 has/have a common characteristic. The or each such SAO category exclusively represents an edge artefact where a pixel is at least almost equal to one of its neighbors (228) and distinctly lower or higher than the other neighbor (226) in a given spatial direction. To “exclusively represent” means that the or each such SAO category does not represent any other edge artefact than the edge artefact in question. This allows for a more accurate SAO compensation for the edge artefact in question.

Examples of novel SAO categories 101-104 which may be included in the plurality of SAO categories 200 are seen as 222a, 222b, 232a and 232b for a first embodiment in FIG. 2b; as 242a, 242b, 252a and 252b for a second embodiment in FIG. 2c; and as 222a, 222b, 232a, 232b, 242a, 242b, 252a and 252b for a third embodiment in FIG. 2d. These embodiments will be described in more detail further below.

Additionally or alternatively, the plurality of SAO categories 200 may include at least one novel combined SAO category jointly representing either said first and second edge artefacts or said third and fourth edge artefacts in combination, where the pixel is not equal to but close to a first one of the neighbors and distinctly lower or higher than a second one of the neighbors. Examples of this latter kind of novel combined SAO category are seen as 262 and 272 for a fifth embodiment in FIG. 2e.

However, the other steps of the method illustrated in FIG. 1 will first be described. In step 120, a block of pixels 114 of video data 112 is obtained. The block of pixels 114 may represent a portion of a current picture frame, for instance in the form of a reconstructed reference block of pixels for use in inter-frame motion prediction of a next block of pixels. Such a reconstructed reference block of pixels may for instance be stored in a frame buffer which is seen at 48 in FIG. 3. Depending on implementation, the block of pixels 114 may alternatively represent an entire picture frame.

Then, in step 130-155 of FIG. 1, the pixels in the block of pixels 114 are evaluated, step 130, with respect to their respective neighbors in a given spatial direction. If the current pixel and its neighbors match any of the SAO categories in the plurality of SAO categories 200 in the given spatial direction, step 140, the offset value associated with the matching SAO category is applied for the current pixel, step 150.

The given spatial direction in which the current pixel and its neighbors are evaluated may be established in a step which as such may be performed in accordance with, for instance, standard HEVC, and is therefore not explicitly shown in FIG. 1. Hence, the given spatial direction may be identified as one of the following:

horizontal (0 degrees)−sao_type_idx=1,

vertical (90 degrees)−sao_type_idx=2,

diagonal (135 degrees)−sao_type_idx=3,

diagonal (45 degrees)−sao_type_idx=4.

Once the pixels in the block of pixels 114 have been processed in steps 130-155, when the method is performed at the encoder side (such as in the video encoder 40 of FIG. 3), information intended for the decoder side (such as in the video decoder 60 of FIG. 4) may be sent in an outgoing encoded video bitstream (962, FIG. 3). The information may represent the spatial direction used for the evaluation in step 130 of the current pixels and their respective neighbors in the block of pixels 114 (i.e., sao_type_idx=1 . . . 4), as well as the offset values of the plurality of SAO categories 200 (e.g. the array SaoOffsetVal as referred to in Chapter 1, if not hard-coded at the encoder and decoder sides).

Embodiments involving novel SAO categories 101-104 will now be described in more detail with reference to FIGS. 2b-2d.

### 2.1. First Embodiment

In the first embodiment seen in FIG. 2b, the plurality of SAO categories 200 includes one or more of the following:
a first SAO category 222a which exclusively represents a first edge artefact where a current (center) pixel 224 is equal to one neighbor 226 (the left neighbor in FIG. 2b) and distinctly lower than the other neighbor 228 (the right neighbor in FIG. 2b) in the given spatial direction,
a second SAO category 222b which exclusively represents a second edge artefact where the current pixel 224 is equal to the other neighbor 228 and distinctly lower than the first neighbor 226 in the given spatial direction,
a third SAO category 232a which exclusively represents a third edge artefact where the current pixel is equal to the first neighbor and distinctly higher than the other neighbor in the given spatial direction, and
a fourth SAO category 232b which exclusively represents a fourth edge artefact where the pixel is equal to the other neighbor and distinctly higher than the first neighbor in the given spatial direction.

The plurality of SAO categories 200 in the first embodiment includes refined versions of one or more of the SAO categories seen in FIG. 2a. It is recalled that the two SAO categories 220, 230 (edgeIdx=1, edgeIdx=3) seen in FIG. 2a represent edge artefacts 220, 230 where the current pixel is equal to one of its neighbors and distinctly lower and higher, respectively, than the other neighbor. These two SAO categories in FIG. 2a do not differentiate between the order among the neighboring pixels; a “left” edge artefact 220a, 230a and a “right” edge artefact 220b, 230b are represented by the same SAO category 220, 230. In contrast, the plurality of SAO categories 200 in the first embodiment of FIG. 2b may include the aforementioned first SAO category 222a (edgeIdx=1) which exclusively represents the edge artefact specifically where the current pixel 224 is equal to its left neighbor 226 and distinctly lower than its right neighbor 228. Additionally or alternatively, the plurality of SAO categories 200 in the first embodiment of FIG. 2b may include the aforementioned second SAO category 222b (edgeIdx=4) which exclusively represents the edge artefact specifically where the current pixel 224 is equal to its right neighbor 228 and distinctly lower than its left neighbor 226. Correspondingly, the aforementioned third and fourth SAO categories 232a, 232b may exclusively represent the edge artefacts where the current pixel is distinctly higher than its right and left neighbors, respectively.

Hence, “right” edge artefacts may be differentiated from “left” edge artefacts, thereby allowing an improved ability to compensate for these edge artefacts. The first embodiment therefore offers an improvement over the standard SAO edge offset categories in HEVC, since it distinguishes between the cases where the differentiating pixel (i.e. the distinctly higher or lower neighbor) is on one side or the other side of the current pixel. As a result, an improved plurality of SAO edge offset categories are provided, being capable of more accurately compensating for one or more of the relevant edge artefacts.

Advantageously (but not necessarily), both the first and the second SAO categories 222a-b and/or both the third and the fourth SAO categories 232a-b are included in the plurality of SAO categories, thereby providing an improved and increased set of SAO edge offset categories being capable of compensating for a broader variety of edge artefacts.

The plurality of SAO categories 200 may also include other SAO categories, for instance some of the SAO categories from FIG. 2a. This is seen in FIG. 2b, where edgeIdx=0 represents the same edge artefact as was referred to as 210 in FIG. 2a, and edgeIdx=10 represents the same edge artefact as was referred to as 240 in FIG. 2a.

Moreover, the plurality of SAO categories 200 may include SAO categories representing artefacts which are not represented by any of the SAO categories in FIG. 2a. Such artefacts can be seen as edgeIdx=2 and edgeIdx=8 in FIG. 2b.

In the first embodiment, steps 130-150 in FIG. 1 for determining and applying a matching SAO category, if any, for a current pixel may advantageously be implemented as follows. An index is calculated as a function edgeIdx=W1*Sign(p(X)−(p(A))+W2*Sign(p(X)−(p(B))+W3, where:
p(X) is a pixel value of the current pixel,
p(A) is a pixel value of one of the neighbors of the current pixel in the given spatial direction,
p(B) is a pixel value of the other neighbor of the current pixel in the given spatial direction, and
W1, W2 and W3 are weight values.

The calculated value of edgeIdx is used as a pointer in a data structure which defines the respective offset values of the plurality of SAO categories 200 so as to obtain the offset value for the matching SAO category. The data structure may, for instance, be an array (such as the one referred to as saoValueArray in this document), containing a list of the respective offset values corresponding to the plurality of SAO categories. In one alternative, the calculated value of edgeIdx may point directly to the correct position of the matching SAO category in the array (e.g. saoValueArray). In another alternative, the calculated value of edgeIdx may point to a position in a table (such as the one referred to as edgeTable in this document), describing a mapping between the different possible values of edgeIdx and the respective positions for the corresponding offset values in the array (e.g. saoValueArray). Other formats of the data structure are however equally possible. Specific values of the weights W1=1, W2=4 and W3=5 will give the edgeIdx values shown in FIG. 2b. Using the weights as multiples of 2 makes it possible to do the computation with left shift (e.g. W1*x=(x<<log2(W1))).

Using a weighted function for calculating edgeIdx is beneficial since it represents an efficient way of performing the evaluation of the current pixel and its neighbors to determine whether they form an edge artefact which matches any of the SAO categories in the improved and increased set of SAO edge offset categories made available according to this first embodiment.

Some possible changes to the syntax and semantics of standard HEVC (see Chapter 1) in order to implement the first embodiment will now be described. It is to be noticed that all proposed syntax and semantic changes to HEVC merely serve exemplifying purposes and that other changes may be relevant, both for the present version of HEVC and for other versions.

edgeIdx=W1*Sign(recPicture[xC+i,yC+j]−recPicture[xC+i+hPos[0],yC+j+vPos[0]])+W2*Sign(recPicture[xC+i,yC+j]−recPicture[xC+i+hPos[1],yC+j+vPos[1]])+W3, with W1=1,W2=4 and W3=5.

Example values of hPos and vPos are found in Chapter 1.

The modification of the reconstructed picture is then obtained by

recSaoPicture[xC+i,yC+j]=recPicture[xC+i,yC+j]+saoValueArray[edgeTable[edgeIdx]], where

edgeTable[11]={1, 3, 8, 0, 5, 0, 6, 0, 7, 4, 2} when W1=1 and W2=4 and W3=5.

edgeTable describes the mapping between edgeIdx and position in the saoValueArray. This is only one example; other mappings are also possible.

It is also possible to omit edgeTable and let the edgeIdx directly point to a position in saoValueArray, e.g:

recSaoPicture[xC+i,yC+j]=recPicture[xC+i,yC+j]+saoValueArray[edgeIdx]

It can be noted that a clipping of the recSaoPicture to appropriate values to stay within the bit depth range may also be appropriate but are not shown here. For example, bit depth equal to 8 for luma has typically a minimum value of 0 and a maximum value of 255.

The mapping between sao_offsets syntax element and the saoValueArray may be found in semantics description in Chapter 1 using NumSaoCategory=8 when sao_idx_type>5, i.e. when edge artefacts are used.

Interpretation of edgeIdx and the signs (first sign, second sign): (−,−) edgeIdx=0 local minima, (+,+) edgeIdx=10 local maxima, (−,0) left edgeIdx=4, (0,−) right edgeIdx=1, (+,0) left edgeIdx=6, (0,+) right edgeIdx=9, (+,−) edgeIdx=2, (−,+) edgeIdx=8, (0,0) edgeIdx=5

The semantics of HEVC (WD4) would be modified to describe the mapping between decoded edge offsets and the saoValueArray as follows (modifications marked in italics):

```
if(saoTypeIdx < 5){
  SaoOffsetVal[ cIdx ][ saoDepth ][ rx ][ ry ][ i ]=0 with i=0 ..10
  SaoOffsetVal[ cIdx ][ saoDepth ][ rx ][ ry ][ TableEo[ i ] ] =
      sao_offset[ cIdx ][ saoDepth ][ rx ][ ry ][ i ] << ( bitDepth −
      Min( bitDepth, 10 ))
with i=0..7 and
TableEo[8]={0, 10, 1, 9, 4, 6, 8, 2}
}else{
  SaoOffsetVal[ cIdx ][ saoDepth ][ rx ][ ry ][ 0 ] = 0
  SaoOffsetVal[ cIdx ][ saoDepth ][ rx ][ ry ][ i+1 ] =
      sao_offset[ cIdx ][ saoDepth ][ rx ][ ry ][ i ] << ( bitDepth −
      Min( bitDepth, 10 ))
      with i = 0..NumSaoCategory − 1
}
```

where TableEo describes the mapping between sao_offsets and saoOffsetVal.

This is only one example when the edgeTable not is used; other mappings are also possible. In this example, 8 edge offsets is used. It is of course also possible to use fewer edge offsets, such as 6 edge offsets. In that case, TableEo[6]={0, 10, 1, 9, 4, 6,} could for instance be used.

An alternative is to compute the offset directly by modification of the saoValueArray to two specific dimensions where the two signs are used as indices:

The modification of the reconstructed picture is then obtained by

recSaoPicture[xC+i,yC+j]=recPicture[xC+i,yC+j]+saoValueArray[Sign(recPicture[xC+i,yC+j]−recPicture[xC+i+hPos[0],yC+j+vPos[0]])+1][Sign(recPicture[xC+i,yC+j]−recPicture[xC+i+hPos[1],yC+j+vPos[1]]+1]

The semantics of HEVC (WD4) would be modified to describe the mapping between decoded edge offsets and the saoValueArray as follows (modifications marked in italics):

```
if(saoTypeIdx < 5){
  SaoOffsetVal[ cIdx ][ saoDepth ][ rx ][ ry ][ i ][ j ] = 0 with i=0 .. 2,
  j=0..2
  SaoOffsetVal[ cIdx ][ saoDepth ][ rx ][ ry ][ TableEo1[ i ]
  [ TableEo2[ i ] ] =
      sao_offset[ cIdx ][ saoDepth ][ rx ][ ry ][ i ] << ( bitDepth −
      Min( bitDepth, 10 ))
with i=0..7 and
TableEo1[10]={0, 2, 1, 1, 0, 1, 0, 2}
TableEo2[10]={0, 2, 0, 2, 1, 1, 2, 0}
}else{
  SaoOffsetVal[ cIdx ][ saoDepth ][ rx ][ ry ][ 0 ] = 0
  SaoOffsetVal[ cIdx ][ saoDepth ][ rx ][ ry ][ i+1 ] =
      sao_offset[ cIdx ][ saoDepth ][ rx ][ ry ][ i ] << ( bitDepth −
      Min( bitDepth, 10 ))
      with i = 0..NumSaoCategory − 1
}
```

where TableEo1 and TableEo2 describes the mapping between the signs and the position in saoOffsetVal and sao_offset. Again, this is only one example; other mappings are also possible.

### 2.2. Second Embodiment

In the second embodiment seen in FIG. 2c, the plurality of SAO categories 200 includes one or more of the following:
a first SAO category 242a which exclusively represents a first edge artefact where a current (center) pixel is not equal to but close to and higher than one neighbor (left neighbor in FIG. 2c) and distinctly lower than the other neighbor (right neighbor in FIG. 2c) in a given spatial direction,
a second SAO category 242b which exclusively represents a second edge artefact where the current pixel is not equal to but close to and higher than said other neighbor and distinctly lower than said one neighbor in the given spatial direction,
a third SAO category 252a which exclusively represents a third edge artefact where the pixel is not equal to but close to and lower than said one neighbor and distinctly higher than said other neighbor in the given spatial direction, and
a fourth SAO category 252b which exclusively represents a fourth edge artefact where the pixel is not equal to but close to and lower than said other neighbor and distinctly higher than said one neighbor in the given spatial direction.

The second embodiment therefore includes SAO categories which are refinements of the edge artefacts seen at 220 and 230 in FIG. 2a. The improvement is twofold. Firstly, the second embodiment (like the first embodiment) differentiates between “left” and “right” edge artefacts. Secondly, the second embodiment identifies and compensates for artefacts where the current pixel and one of its neighbors have not identical but similar pixel values, which both are distinctly different from the pixel value of the other neighbor. Hence, a broader range of edge artefacts can be compensated for.

The plurality of SAO categories 200 may also include other SAO categories, for instance some of the SAO categories from FIG. 2a or 2b, such as any or all of the SAO categories 222a-b and 232a-b seen in FIG. 2b.

In the second embodiment, steps 130-150 in FIG. 1 for determining and applying a matching SAO category, if any, for a current pixel may be implemented as follows. An index is calculated as a function edgeIdx=f(Sign(−2*p(X)+p(A)+p(B))), where:
p(X) is a pixel value of the current pixel,
p(A) is a pixel value of one of the neighbors of the current pixel in the given spatial direction, and
p(B) is a pixel value of the other neighbor of the current pixel in the given spatial direction.

The calculated value of edgeIdx may then be used as a pointer in a data structure which defines the respective offset values of the plurality of SAO categories 200 so as to obtain the offset value for the matching SAO category.

As with the first embodiment, the data structure may, for instance, be an array (e.g. saoValueArray), containing a list of the respective offset values corresponding to the plurality of SAO categories. In one alternative, the calculated value of edgeIdx may point directly to the correct position of the matching SAO category in the array (e.g. saoValueArray). In another alternative, the calculated value of edgeIdx may point to a position in a table (e.g. edgeTable), describing a mapping between the different possible values of edgeIdx and the respective positions for the corresponding offset values in the array (e.g. saoValueArray). Other formats of the data structure are however equally possible.

In this second embodiment, the function for calculating edgeIdx is based on the sign of a pixel difference involving the current pixel and both of its neighbors, wherein the current (center) pixel has a different sign than its neighbors. This is beneficial, since it represents an efficient way of evaluating the current pixels and its neighbors to determine whether they form an edge artefact which matches any of the SAO categories in the improved and increased set of SAO edge offset categories made available according to this second embodiment.

2.3. Third Embodiment

In the third embodiment seen in FIG. 2d, the plurality of SAO categories 200 includes a combination of SAO categories from the first and second embodiments seen in FIGS. 2b and 2c. Hence, the third embodiment includes one or more of the SAO categories 222a, 222b, 232a and 232b seen in FIG. 2b, as well as one or more of the SAO categories 242a, 224b, 252a and 252b seen in FIG. 2c. Advantageously, all of these SAO categories are included in the plurality of SAO categories 200. The third embodiment therefore offers a further improvement over the standard SAO edge offset categories in HEVC, allowing compensation for an even broader range of edge artefacts.

In the third embodiment, steps 130-150 in FIG. 1 for determining and applying a matching SAO category, if any, for a current pixel may be implemented as follows. An index is calculated as a function edgeIdx=f(Sign(−2*p(X)+p(A)+p(B)))+W1*Sign(p(X)−p(A))+W2*Sign(p(X)−p(B))+W3, where:
p(X) is a pixel value of the current pixel,
p(A) is a pixel value of one of the neighbors of the current pixel in the given spatial direction,
p(B) is a pixel value of the other neighbor of the current pixel in the given spatial direction, and

W1, W2 and W3 are weight values.

The calculated value of edgeIdx may then be used as a pointer in a data structure which defines the respective offset values of the plurality of SAO categories 200 so as to obtain the offset value for the matching SAO category.

This third embodiment may thus calculate edgeIdx as a function of weighted two-pixel sign operations, like in the first embodiment, combined with a three-pixel sign operation, like in the second embodiment.

Some possible changes to the syntax and semantics of standard HEVC (see Chapter 1) in order to implement the third embodiment will now be described.

edgeIdx=19+Sign(−2*recPicture[xC+i,yC+j]+recPicture[xC+i+hPos[0],yC+j+vPos[0]]+recPicture[xC+i+hPos[1],yC+j+vPos[1]])+4*Sign(recPicture[xC+i,yC+j]−recPicture[xC+i+hPos[0],yC+j+vPos[0]])+16*Sign(recPicture[xC+i,yC+j]−recPicture[xC+i+hPos[1],yC+j+vPos[1]]),

where hPos and vPos are same as in Chapter 1. The categorization requires no multiplications since it can be implemented with shifts.

The reconstructed picture buffer is modified as:

recSaoPicture[xC+i,yC+j]=recPicture[xC+i,yC+j]+saoValueArray[edgeTable [edgeIdx]] with i=0 . . . nS-1 and j=0 . . . nS-1,edgeTable[39]={{1,0,0,0,3,0,7,11,9,0,0,0,0,0,0,0,5,0,0,13,0,0,4,0,0,0,0,0,0,0,8,12,10,0,6,0,0,0,2}}

It can be noted that a clipping of the recSaoPicture to appropriate values to stay within the bit depth range may also be required but is not shown here. For example, bit depth equal to 8 for luma has a typical minimum value of 0 and maximum value of 255.

It is also possible to omit edgeTable and let the edgeIdx directly point to a position in saoValueArray, hence:

recSaoPicture[xC+i,yC+j]=recPicture[xC+i,yC+j]+saoValueArray[[edgeIdx]

with i=0 . . . nS-1 and j=0 . . . nS-1

An advantage with this is that a re-mapping of edgeIdx before accessing the saoValueArray is not required.

The proposed categorization can determine up to 13 individual edge offsets, as seen in FIG. 2d. The same categorization may be used for luma and chroma components.

The semantics of HEVC (WD4) would be modified as follows (modifications marked in italics). In this example, 10 edge offsets are used.

An array SaoOffsetVal is specified as:

```
if(saoTypeIdx < 5){
  SaoOffsetVal[ cIdx ][ saoDepth ][ rx ][ ry ][ i ] = 0 with i=0 .. 38
  SaoOffsetVal[ cIdx ][ saoDepth ][ rx ][ ry ][ TableEo[i] ] =
      sao_offset[ cIdx ][ saoDepth ][ rx ][ ry ][ i ] << ( bitDepth −
      Min( bitDepth, 10 ))
with i = 0..9
where TableEo = {0, 38, 4, 22, 16, 34, 6, 30, 8, 32}
}else{
  SaoOffsetVal[ cIdx ][ saoDepth ][ rx ][ ry ][ 0 ] = 0
  SaoOffsetVal[ cIdx ][ saoDepth ][ rx ][ ry ][ i+1 ] =
      sao_offset[ cIdx ][ saoDepth ][ rx ][ ry ][ i ] << ( bitDepth −
      Min( bitDepth, 10 ))
      with i = 0..NumSaoCategory − 1
}
```

where TableEo describes the mapping between sao_offsets and saoOffsetVal. This is only one example when edgeTable is not used in the generation of saoRecPicture; other mappings are also possible.

### 2.4. Fourth Embodiment

The fourth embodiment is a variant of the third embodiment, here too being based on a combination of SAO categories from the first and second embodiments seen in FIGS. 2b and 2c, as seen in FIG. 2d. The difference is that in the fourth embodiment, steps 130-150 in FIG. 1 for determining and applying a matching SAO category, if any, for a current pixel is not implemented by calculating an index as a function edgeIdx.

Instead, the offset value of the matching SAO category for said current pixel is determined from a multi-dimensional lookup table. More specifically, a first value to address a first dimension in the multi-dimensional lookup table is calculated as f(Sign(p(X)−p(A))). A second value to address a second dimension in the multi-dimensional lookup table is calculated as f(Sign(p(X)−p(B))). A third value to address a third dimension in the multi-dimensional lookup table is calculated as f(Sign(−2*p(X)+p(A)+p(B))), where:
p(X) is a pixel value of the current pixel,
p(A) is a pixel value of one of the neighbors of the current pixel in the given spatial direction, and
p(B) is a pixel value of the other neighbor of the current pixel in the given spatial direction.

This fourth embodiment thus offers an alternative way of determining the offset value of a matching SAO category in the increased and improved plurality of SAO categories from the first and second embodiments, by using a lookup table having at least three dimensions, instead of calculating an index (e.g. edgeIdx) to a one-dimensional data structure.

The fourth embodiment may for instance be implemented as follows.

The reconstructed picture in the SAO decoding process is obtained by:

recSaoPicture[xC+i,yC+j]=recPicture[xC+i,yC+j]+saoValueArray[Sign(recPicture[xC+i,yC+j]−recPicture[xC+i+hPos[0],yC+j+vPos[0]])+1][Sign(recPicture[xC+i,yC+j]−recPicture[xC+i+hPos[1],yC+j+vPos[1]]+1][Sign(−2*recPicture[xC+i,yC+j]+recPicture[xC+i+hPos[0],yC+j+vPos[0]]+recPicture[xC+i+hPos[1],yC+j+vPos[1]])+1], where:

recPicture is a reconstructed picture possibly after deblocking, and

saoValueArray[3][3][3] contains the offsets (but many positions can be zero to avoid too much overhead for the coding of the offsets). Example values of hPos and vPos are found in Chapter 1.

As already noted for previous embodiments, a clipping of the recSaoPicture to appropriate values to stay within the bit depth range may also be required but is not shown here.

The encoder can for example select to submit 10 edge offsets that correspond to edgeIdx=0, 38, 4, 22, 16, 34, 6, 30, 8, and 32 in FIG. 2d. Then, NumSaoClass[saoTypeIdx]=10 for saoTypeIdx=1.4. The decoder then decodes 10 edge offsets.

The semantics of HEVC (WD4) would be modified as follows (modifications marked in italics) to describe the mapping between decoded edge offsets and the saoValueArray:

```
    if(saoTypeIdx < 5){
      SaoOffsetVal[ cIdx ][ saoDepth ][ rx ][ ry ][ i ][ j ][ k ] = 0 with i=
      0.. 2, j=0..2, k=0..2
      SaoOffsetVal[ cIdx ][ saoDepth ][ rx ][ ry ][ TableEo1[ i ]
      [ TableEo2[ i ] ][ TableEo3[ i ] ]
=
          sao_offset[ cIdx ][ saoDepth ][ rx ][ ry ][ i ] <<
          ( bitDepth − Min( bitDepth, 10 ))
    with i=0..9 and
    TableEo1[10]={0, 2, 1, 2, 0, 1, 2, 0, 2, 0}
    TableEo2[10]={0, 2, 0, 1, 1, 2, 0, 2, 0, 2}
    TableEo3[10]={2, 0, 2, 0, 2, 0, 0, 0, 2, 2}
    }else{
      SaoOffsetVal[ cIdx ][ saoDepth ][ rx ][ ry ][ 0 ] = 0
      SaoOffsetVal[ cIdx ][ saoDepth ][ rx ][ ry ][ i+1 ] =
          sao_offset[ cIdx ][ saoDepth ][ rx ][ ry ][ i ] <<
          ( bitDepth − Min( bitDepth, 10 ))
          with i = 0..NumSaoCategory − 1
    }
```

where TableEo1, TableEo2 and TableEo3 describe the mapping between the signs and the position in saoOffsetVal and sao_offset. This is only one example; other mappings are also possible.

### 2.5. Fifth Embodiment

A fifth embodiment is shown in FIG. 2e. According to this or other embodiments, the plurality of SAO categories 200 may include at least one combined SAO category jointly representing either the first and second edge artefacts or the third and fourth edge artefacts in combination, where the pixel is not equal to but close to a first one of the neighbors and distinctly lower or higher than a second one of the neighbors.

More specifically, the fifth embodiment shown in FIG. 2e comprises a first combined SAO category 262 which jointly represents the first and second edge artefacts 242a and 242b referred to above for the second and third embodiments. The fifth embodiment shown in FIG. 2e also comprises a second combined SAO category 272 which jointly represents the third and fourth edge artefacts 252a and 252b referred to above for the second and third embodiments.

As seen in FIG. 2e, the fifth embodiment may also comprise any of the SAO categories 210-240 shown in and already explained for FIGS. 2a-d.

### 3. Implementations of the Improved SAO Compensation of Video Data

Generally, the functionality of the methods described in Chapter 2 may be implemented in hardware (e.g. special purpose circuits, such as ASICs (Application Specific Integrated Circuits), in software (e.g. computer program code running on a general purpose processor), or as any combination thereof.

FIG. 3 is a schematic block diagram of a video encoder 40 for encoding a block of pixels in a video frame of a video sequence according to one possible implementation. The video encoder 40 comprises a control device 100 which may control the overall operation of the video encoder 40. Also, the control device 100 comprises an SAO module 304 configured to perform the method shown in FIG. 1. The control device 100 moreover comprises a deblocking module 302. Hence, FIG. 3 exemplifies a scenario when deblocking is used and SAO compensation is applied once deblocking effects have been compensated for. If deblocking is not used, the deblocking functionality may be omitted from the control device 100.

A current block of pixels is predicted by performing motion estimation by a motion estimator 50 from an already provided block of pixels in the same frame or in a previous frame. The result of the motion estimation is a motion or displacement vector associated with the reference block, in the case of inter prediction. The motion vector is utilized by a motion compensator 50 for outputting an inter prediction of the block of pixels.

An intra predictor 49 computes an intra prediction of the current block of pixels. The outputs from the motion estimator/compensator 50 and the intra predictor 49 are input to a selector 51 that either selects intra prediction or inter prediction for the current block of pixels. The output from the selector 51 is input to an error calculator in the form of an adder 41 that also receives the pixel values of the current block of pixels. The adder 41 calculates and outputs a residual error as the difference in pixel values between the block of pixels and its prediction.

The error is transformed in a transformer 42, such as by way of a discrete cosine transform, and quantized by a quantizer 43 followed by coding in an encoder 44, such as by way of entropy encoding. In inter coding, also the estimated motion vector is brought to the encoder 44 for generating the coded representation of the current block of pixels.

The transformed and quantized residual error for the current block of pixels is also provided to an inverse quantizer 45 and inverse transformer 46 to retrieve the original residual error. This error is added by an adder 47 to the block prediction output from the motion compensator 50 or the intra predictor 49 to create a reference block of pixels that can be used in the prediction and coding of a next block of pixels. This new reference block may be first processed by the control device 100 to control the deblocking filtering that is applied by the deblocking module 302 to the reference block of pixels to combat any blocking artefacts. The processed new reference block is then temporarily stored in a frame buffer 48, where it is available to the intra predictor 49 and the motion estimator/compensator 50. As already mentioned, the SAO module 304 of the control device 100 is further configured to perform SAO compensation by performing the method shown in FIG. 1, wherein the output of the adder 47 or the deblocking module 302 represents the video data 112 referred to in FIG. 1, and the output of the entropy encoder 44 represents an outgoing video stream 962 which will be referred to again in conjunction with FIG. 9a.

FIG. 4 is a corresponding schematic block diagram of a decoder 60 comprising a control device 100 which may control the overall operation of the video decoder 60. Also, the control device 100 comprises an SAO module 404 configured to perform the method shown in FIG. 1. The decoder 60 comprises a decoder 61, such as an entropy decoder, for decoding an encoded representation of a block of pixels to get a set of quantized and transformed residual errors. These residual errors are dequantized in an inverse quantizer 62 and inverse transformed by an inverse transformer 63 to get a set of residual errors.

These residual errors are added in an adder 64 to the pixel values of a reference block of pixels. The reference block is determined by a motion estimator/compensator 67 or intra predictor 66, depending on whether inter or intra prediction is performed. A selector 68 is thereby interconnected to the adder 64 and the motion estimator/-compensator 67 and the intra predictor 66. The resulting decoded block of pixels output from the adder 64 is input to the control device 100 in order to control any deblocking filter (deblocking module 402) that is applied to combat any blocking artefacts. The filtered block of pixels is output from the decoder 60 and is furthermore preferably temporarily provided to a frame buffer 65 and can be used as a reference block of pixels for a subsequent block of pixels to be decoded. The frame buffer 65 is thereby connected to the motion estimator/compensator 67 to make the stored blocks of pixels available to the motion estimator/compensator 67. As already mentioned, the SAO module 404 of the control device 100 is further configured to perform SAO compensation by performing the method shown in FIG. 1, wherein the output of the adder 64 or the deblocking module 402 represents the video data 112 referred to in FIG. 1 (and referred to as 902′ in FIG. 9b), and the input of the entropy decoder 61 represents an incoming video stream 902′ referred to in FIG. 9b.

The output from the adder 64 is preferably also input to the intra predictor 66 to be used as an unfiltered reference block of pixels.

In the embodiments disclosed in FIGS. 3 and 4, the control device 100 controls deblocking filtering and also the SAO compensation in the form of so-called in-loop filtering. In an alternative implementation of the decoder 60, the control device 100 is arranged to perform so called post-processing. In such a case, the control device 100 operates on the output frames outside of the loop formed by the adder 64, the frame buffer 65, the intra predictor 66, the motion estimator/compensator 67 and the selector 68 to perform SAO compensation as described above. Likewise, in an alternative implementation of the encoder 40, the control device 100 may arranged to perform so called pre-processing of the video data before the encoding loop by performing SAO compensation as described above. One reason for this may be to remove noise from the video source and improve the video compression efficiency.

Combinations are also possible, where the control device 100 of the encoder 40 may act as a pre-filter before the encoding of the video source and the corresponding control device 100 of the decoder 60 may act as a post-filter after the decoding.

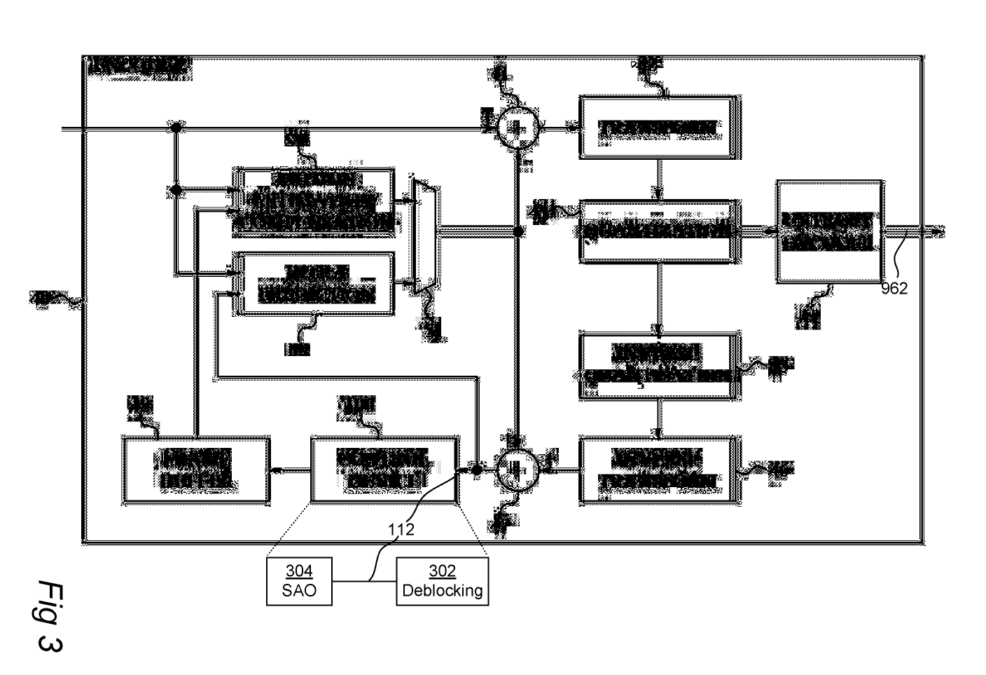

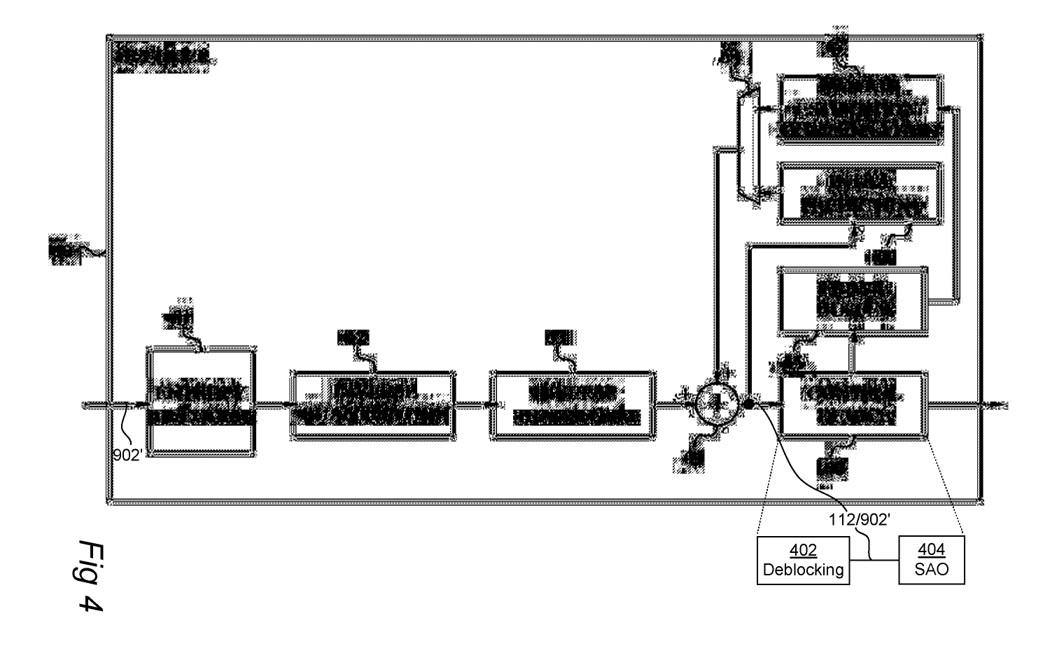

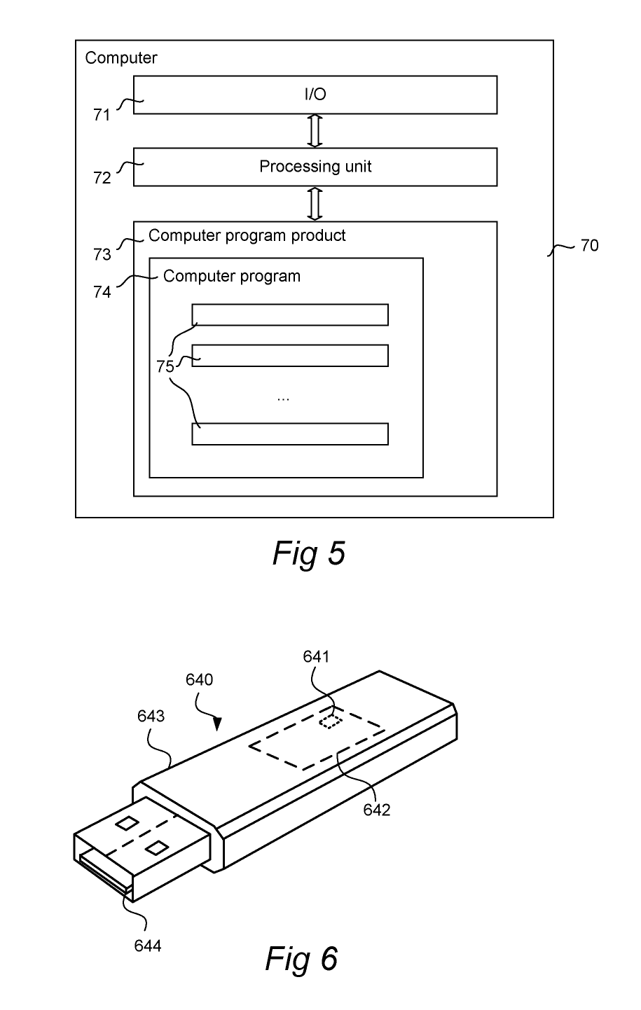

FIG. 5 schematically illustrates an embodiment of a computer 70 having a processing unit 72, such as a DSP (Digital Signal Processor) or CPU (Central Processing Unit). The processing unit 72 can be a single unit or a plurality of units for performing different steps of the methods described herein. The computer 70 also comprises an input/output (I/O) unit 71 for receiving recorded or generated video frames or encoded video frames and outputting encoded video frame or decoded video data. The I/O unit 71 has been illustrated as a single unit in FIG. 5 but can likewise be in the form of a separate input unit and a separate output unit.

Furthermore, the computer 70 comprises at least one computer program product 73 in the form of a non-volatile memory, for instance an EEPROM (Electrically Erasable Programmable Read-Only Memory), a flash memory or a disk drive. The computer program product 73 comprises a computer program 74, which comprises computer program code means 75 which, when run on or executed by the computer 70, such as by the processing unit 72, cause the computer 70 to perform the steps of any of the methods described in the foregoing.

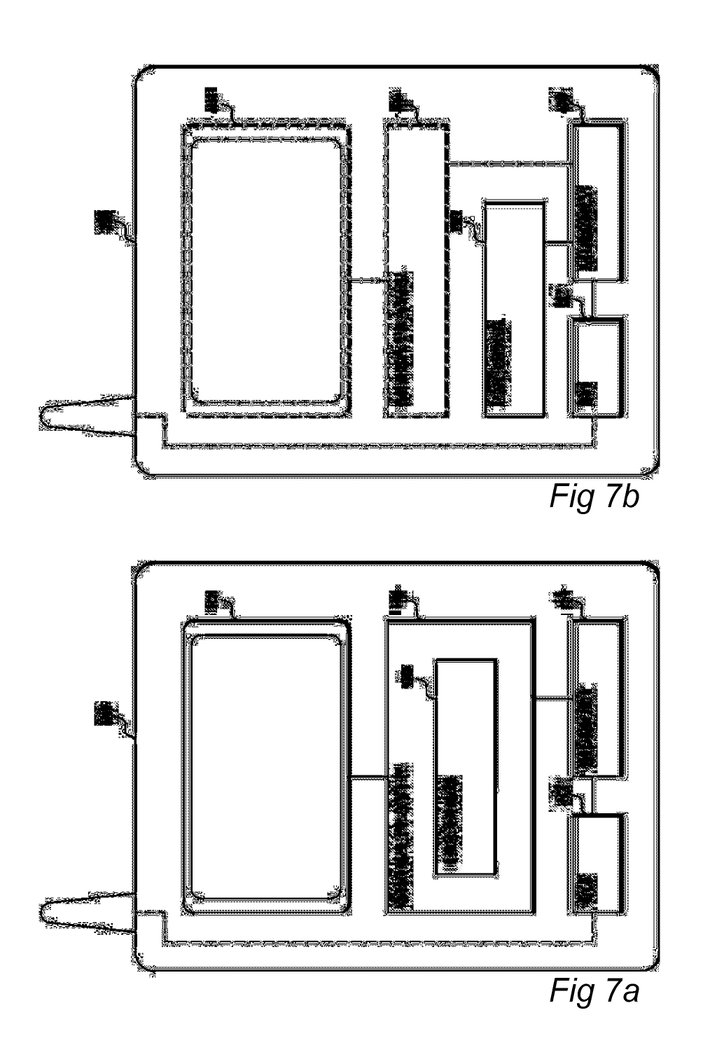

The computer 70 of FIG. 5 can be a user equipment 80, as seen in FIGS. 7a and 7b, or be present in such a user equipment 80. In such a case, the user equipment 80 may additionally comprise or be connected to a display to display video data.

FIG. 6 shows a schematic view of a computer readable storage medium 640 which may be used to accommodate instructions for performing the functionality of any of the disclosed methods. In the embodiment shown in FIG. 6, the computer-readable medium 640 is a memory stick, such as a Universal Serial Bus (USB) stick. The USB stick 640 comprises a housing 643 having an interface, such as a connector 644, and a memory chip 642. The memory chip 642 is a flash memory, i.e. a non-volatile data storage that can be electrically erased and re-programmed. The memory chip 642 is programmed with instructions 641 that when loaded (possibly via the connector 644) into a processor, such as the processing unit 72 of FIG. 5, cause execution of any of the methods disclosed herein. The USB stick 640 is arranged to be connected to and read by a reading device, such as the network device 30 seen in FIG. 8 or the computer 70 seen in FIG. 5, for loading the instructions into the processor. It should be noted that a computer-readable storage medium can also be other media, such as compact discs, digital video discs, hard drives or other memory technologies commonly used. The instructions can also be downloaded from the computer-readable storage medium via a wireless interface to be loaded into the processor.

FIG. 7a is a schematic block diagram of the aforementioned user equipment or media terminal 80 housing a decoder 60, such as the video decoder described above with respect to FIG. 4. The user equipment 80 can be any device having media decoding functions that operate on an encoded video stream of encoded video frames to thereby decode the video frames and make the video data available. Non-limiting examples of such devices include mobile telephones and other portable media players, tablets, desktops, notebooks, personal video recorders, multimedia players, video streaming servers, set-top boxes, TVs, computers, decoders, game consoles, etc. The user equipment 80 comprises a memory 84 configured to store encoded video frames. These encoded video frames can have been generated by the user equipment 80 itself. Alternatively, the encoded video frames are generated by some other device and wirelessly transmitted or transmitted by wire to the user equipment 80. The user equipment 80 then comprises a transceiver (transmitter and receiver) or input and output port 82 to achieve the data transfer.

The encoded video frames are brought from the memory 84 to the decoder 60. The decoder 60 comprises a control device, such as control device 100 referred to above for FIG. 4, being configured to perform SAO compensation according to the method disclosed with respect to FIG. 1. The decoder 60 then decodes the encoded video frames into decoded video frames. The decoded video frames are provided to a media player 86 that is configured to render the decoded video frames into video data that is displayable on a display or screen 88 in or connected to the user equipment 80.

In FIG. 7a, the user equipment 80 has been illustrated as comprising both the decoder 60 and the media player 86, with the decoder 60 implemented as a part of the media player 86. This should, however, merely be seen as an illustrative but non-limiting example of an implementation embodiment for the user equipment 80. Also distributed implementations where the decoder 60 and the media player 86 are provided in two physically separated devices are possible and within the scope of user equipment 80 as used herein. The display 88 could also be provided as a separate device connected to the user equipment 80, where the actual data processing is taking place.

FIG. 7b illustrates another embodiment of a user equipment 80 that comprises an encoder 40, such as the video encoder of FIG. 3, comprising a control device (e.g. control device 100) configured to perform SAO compensation according to the method disclosed with respect to FIG. 1. The encoder 40 is then configured to encode video frames received by the I/O unit 82 and/or generated by the user equipment 80 itself. In the latter case, the user equipment 80 preferably comprises a media engine or recorder, such as in the form of or connected to a (video) camera. The user equipment 80 may optionally also comprise a media player 86, such as a media player 86 with a decoder and control device according to the embodiments, and a display 88.

As illustrated in FIG. 8, the encoder 40 and/or decoder 60, such as illustrated in FIGS. 3 and 4, may be implemented in a network device 30 being or belonging to a network node in a communication network 32 between a sending unit 34, such as a user equipment, and a receiving user equipment 36. Such a network device 30 may be a device for converting video according to one video coding standard to another video coding standard, for example, if it has been established that the receiving user equipment 36 is only capable of or prefers another video coding standard than the one sent from the sending unit 34. The network device 30 can be in the form of or comprised in a radio base station (RBS), a NodeB, an Evolved NodeB, or any other network node in a communication network 32, such as a radio-based network

### 4. Improved SAO Compensation of Video Data Based on Switching Between First and Second SAO Categories

FIGS. 9a and 9b illustrate an alternative embodiment which is able to switch between first and second sets of SAO categories and thereby provides for a coding-efficient improvement in SAO compensation.

This will now be described for the video encoder side and the video decoder side, respectively, with reference to FIGS. 9a and 9b.

FIG. 9a illustrates a method of SAO compensation of video data in a video encoder. The video encoder may, for instance, be the video encoder 40 described above with reference to FIG. 3. According to the method in FIG. 9a, a first set of SAO categories 922 and a second set of SAO categories 924 are provided. The first set of SAO categories 922 includes fewer SAO categories than the second set of SAO categories 924; however, all SAO categories in the first and second sets of SAO categories 922, 924 pertain to edge artefacts.

The first set of SAO categories 922 may, for instance, be the standard set of SAO categories 210-240 seen in FIG. 2a.

The second set of SAO categories 924 may, advantageously, include some or all of the SAO categories included in the plurality of SAO categories 200 in the first, second or third embodiments as seen in FIGS. 2b-d.

The first and second sets of SAO categories 922, 924 are however not limited to these configurations. Other edge artefacts, and in other numbers, may be used for the first set of SAO categories 922 as well as for the second set of SAO categories 924.

The steps of the method illustrated in FIG. 9a will now be described. In step 910, a block of pixels 914 of video data 912 is obtained. Step 910 may essentially be identical to step 120 of FIG. 1a.

In step 920, a current set of SAO categories 926 is selected for the block of pixels 914 among said first and second sets of SAO categories 922-924. In one embodiment, this involves assessing a Rate Distortion (RD) cost associated with using the first and the second set of SAO categories, respectively, for the block of pixels 914. Thus, it may be assessed for the block of pixels 914 if it is more efficient to encode many offsets or few offsets considering the distortion from applying the offsets and the number of bits required to encode the offsets. The one among the first and second sets of SAO categories 922, 924 which yields the lowest rate distortion cost is then chosen as the current set of SAO categories 926. Such an assessment of the RD cost associated with using the first and the second set of SAO categories 922, 924, respectively, for the block of pixels 114 may be based on any existing method for Rate-Distortion Optimization (RDO), as should be apparent to a person skilled in the art. Reference is for instance made to any of the methods described in “Rate-Distortion Optimization for Video Compression”, Gary J. Sullivan and Thomas Wiegand, IEEE Signal Processing Magazine, 1053-5888/98, November 1998. In Rate-Distortion Optimization an overall metric is calculated to capture both the fidelity of the SAO modified signal compared to the source pixel values and also the number of bits required to encode the SAO parameters (offset values, sao type etc). Such an overall cost can be defined as c=d+λ*b where c is the RDO cost, d is the sum of absolute value difference between source pixel values and pixel values after application of SAO with example parameters (could also be sum of squared errors) and is a scaling factor that depends on the Quantization parameter (QP) that is used in the encoding.

Then, in steps 930-955 of FIG. 9a, the pixels in the block of pixels 914 are evaluated with respect to their respective neighbors. If the current pixel and its neighbors match any of the SAO categories in the selected current set of SAO categories 926, the offset value associated with the matching SAO category is applied for the current pixel. Steps 930-955 of FIG. 9a may essentially be identical to 130-155 of FIG. 1a.

In step 960, an indication 964 of the selected current set of SAO categories 926 is provided in an outgoing encoded video bitstream 962. The indication 964 is intended for a video decoder, such as the video decoder 60 shown in FIG. 4, and will be used in the corresponding method performed at the decoder side (see description of FIG. 9b below). Hence, thanks to the provision of the indication 964, the video decoder will be able to apply the correct set of SAO categories among said first and second sets of SAO categories when processing the block of pixel during video decoding.

The indication 964 may, for instance, be given in the form of a flag or other information in the outgoing encoded video bitstream 962. One example of such a flag is referred to as sao_eo_group_flag in Chapter 1 above. The indication 964 may for instance be sent as part of a data structure 963 in the outgoing encoded video bitstream 962, wherein the data structure 963 comprises:

the indication 964 (e.g. sao_eo_group_flag);

information representing the direction used for the evaluation in step 930 of the current pixels and their respective neighbors in the block of pixels 914, where the direction may be one of:
horizontal (0 degrees)−sao_type_idx=1,
vertical (90 degrees)−sao_type_idx=2,
diagonal (135 degrees)−sao_type_idx=3, and
diagonal (45 degrees)−sao_type_idx=4; and

information representing the offset values of the selected current set of SAO categories 926 (e.g. the array SaoOffsetVal as referred to in Chapter 1).

FIG. 9b illustrates a corresponding method of SAO compensation of video data in a video decoder, using the first set of SAO categories and second set of SAO categories as referred to above. The video decoder may, for instance, be the video decoder 60 described with reference to FIG. 4. Steps or elements in the method of FIG. 9b which are the same as or correspond to steps or elements in the method of FIG. 9a have been given the same reference numeral as in FIG. 9a, however suffixed by a “prime” character.

In step 905′, an indication 904′ of a current set of SAO categories 926′ to be selected is determined from an incoming encoded video bitstream 902′. The incoming encoded video bitstream 902′ may typically be the same as the outgoing encoded video bitstream 962 generated at the video encoder side in FIG. 9a, and the indication 904′ will thus correspond to the indication 964 (e.g. flag or information) provided by the video encoder 40 in step 960 of FIG. 9a. Therefore, the indication 904′ may be part of a data structure 903′ which is identical to the data structure 963 described above for FIG. 9a.

In step 910′, a block of pixels 914′ of video data 912′ is obtained, for instance in the form of a reconstructed reference block of pixels for use in inter-frame motion prediction of a next block of pixels. Such a reconstructed reference block of pixels may for instance be stored in a frame buffer which is seen at 65 in FIG. 4.

In step 920′, a current set of SAO categories 926′ is selected for the block of pixels 914′ among said first and second sets of SAO categories 922′-924′ based on the determined indication 904′.

Then, in step 930′-955′, the pixels in the block of pixels 914′ are evaluated with respect to a given SAO context, which may be SAO edge offsets or SAO band offsets. If the current pixel and its context match any of the SAO categories in the selected current set of SAO categories 926, the offset value associated with the matching SAO category is applied for the current pixel. Steps 930′-955′ may be essentially identical to the corresponding steps 930-955 of FIG. 9a.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible.

1-18. (canceled)

19. A method of sample adaptive offset (SAO) compensation of video data, wherein pixels in the video data are classified into SAO categories, each SAO category representing a possible edge artifact and defining a corresponding offset value to be applied to pixels in the respective SAO category to compensate for the edge artifact, the method comprising:
providing a plurality of SAO categories, the plurality of SAO categories including one or more of the following:
a first SAO category exclusively representing a first edge artifact where a pixel is at least almost equal to one of its neighbors and distinctly lower than the other neighbor in a given spatial direction,
a second SAO category exclusively representing a second edge artifact where the pixel is at least almost equal to said other neighbor and distinctly lower than said one neighbor in the given spatial direction,
a third SAO category exclusively representing a third edge artifact where the pixel is at least almost equal to said one neighbor and distinctly higher than said other neighbor in the given spatial direction,
a fourth SAO category exclusively representing a fourth edge artifact where the pixel is at least almost equal to said other neighbor and distinctly higher than said one neighbor in the given spatial direction, and
a combined SAO category jointly representing either said first and second edge artifacts or said third and fourth edge artifacts in combination, where the pixel is not equal to but close to a first one of the neighbors and distinctly lower or higher than a second one of the neighbors;
obtaining a block of pixels of video data; and
for pixels in said block of pixels:
evaluating a current pixel with respect to its neighbors for a match with any of the SAO categories in said plurality of SAO categories; and
in case of a match, applying the offset value of the matching SAO category for said current pixel, wherein:
the first SAO category represents the first edge artifact where the pixel is not equal to but close to and higher than said one neighbor and distinctly lower than said other neighbor in the given spatial direction,
the second SAO category represents the second edge artifact where the pixel is not equal to but close to and higher than said other neighbor and distinctly lower than said one neighbor in the given spatial direction,
the third SAO category represents the third edge artifact where the pixel is not equal to but close to and lower than said one neighbor and distinctly higher than said other neighbor in the given spatial direction, and
the fourth SAO category represents the fourth edge artifact where the pixel is not equal to but close to and lower than said other neighbor and distinctly higher than said one neighbor in the given spatial direction.

20. The method of claim 19, wherein:
the first SAO category exclusively represents the first edge artifact where the pixel is equal to said one neighbor and distinctly lower than said other neighbor in the given spatial direction,
the second SAO category exclusively represents the second edge artifact where the pixel is equal to said other neighbor and distinctly lower than said one neighbor in the given spatial direction,
the third SAO category exclusively represents the third edge artifact where the pixel is equal to said one neighbor and distinctly higher than said other neighbor in the given spatial direction, and
the fourth SAO category exclusively represents the fourth edge artifact where the pixel is equal to said other neighbor and distinctly higher than said one neighbor in the given spatial direction.

21. The method of claim 20, wherein evaluating the current pixel with respect to its neighbors for a match with any of the SAO categories in the plurality of SAO categories and, in case of a match, applying the offset value of the matching SAO category for said current pixel comprises:
calculating an index as a function edgeIdx=W1*Sign(p(X)−(p(A))+W2*Sign(p(X)−(p(B))+W3, where:
p(X) is a pixel value of the current pixel,
p(A) is a pixel value of one of the neighbors of the current pixel in the given spatial direction,
p(B) is a pixel value of the other neighbor of the current pixel in the given spatial direction, and
W1, W2 and W3 are weight values; and
using the calculated value of edgeIdx as a pointer in a data structure which defines the respective offset values of the plurality of SAO categories so as to obtain the offset value for the matching SAO category.

22. The method of claim 19, wherein evaluating a current pixel with respect to its neighbors for a match with any of the SAO categories in the plurality of SAO categories and, in case of a match, applying the offset value of the matching SAO category for said current pixel comprises:
calculating an index as a function edgeIdx=f(Sign(−2*p(X)+p(A)+p(B))), where:
p(X) is a pixel value of the current pixel,
p(A) is a pixel value of one of the neighbors of the current pixel in the given spatial direction, and
p(B) is a pixel value of the other neighbor of the current pixel in the given spatial direction; and
using the calculated value of edgeIdx as a pointer in a data structure which defines the respective offset values of the plurality of SAO categories so as to obtain the offset value for the matching SAO category.

23. The method of claim 20, wherein the provided plurality of SAO categories further includes one or more of the following:
a fifth SAO category representing a fifth edge artifact where the pixel is not equal to but close to and higher than said one neighbor and distinctly lower than said other neighbor in the given spatial direction,
a sixth SAO category representing a sixth edge artifact where the pixel is not equal to but close to and higher than said other neighbor and distinctly lower than said one neighbor in the given spatial direction,
a seventh SAO category representing a seventh edge artifact where the pixel is not equal to but close to and lower than said one neighbor and distinctly higher than said other neighbor in the given spatial direction, and
an eighth SAO category representing an eighth edge artifact where the pixel is not equal to but close to and lower than said other neighbor and distinctly higher than said one neighbor in the given spatial direction.

24. The method of claim 23, wherein evaluating a current pixel with respect to its neighbors for a match with any of the SAO categories in the plurality of SAO categories and, in case of a match, applying the offset value of the matching SAO category for said current pixel comprises:
calculating an index as a function edgeIdx=f(Sign(−2*p(X)+p(A)+p(B)))+W1*Sign(p(X)−p(A))+W2*Sign(p(X)−p(B))+W3, where:
p(X) is a pixel value of the current pixel,
p(A) is a pixel value of one of the neighbors of the current pixel in the given spatial direction,
p(B) is a pixel value of the other neighbor of the current pixel in the given spatial direction, and
W1, W2 and W3 are weight values; and;
using the calculated value of edgeIdx as a pointer in a data structure which defines the respective offset values of the plurality of SAO categories so as to obtain the offset value for the matching SAO category.

25. The method of claim 23, wherein evaluating a current pixel with respect to its neighbors for a match with any of the SAO categories in the plurality of SAO categories and, in case of a match, applying the offset value of the matching SAO category for said current pixel comprises:
determining the offset value of the matching SAO category for said current pixel from a multi-dimensional lookup table, wherein:
a first value to address a first dimension in the multi-dimensional lookup table is calculated as f(Sign(p(X)−p(A))),
a second value to address a second dimension in the multi-dimensional lookup table is calculated as f(Sign(p(X)−p(B))), and
a third value to address a third dimension in the multi-dimensional lookup table is calculated as f(Sign(−2*p(X)+p(A)+p(B))), where:
p(X) is a pixel value of the current pixel,
p(A) is a pixel value of one of the neighbors of the current pixel in the given spatial direction, and
p(B) is a pixel value of the other neighbor of the current pixel in the given spatial direction.

26. The method of claim 19, the method being performed upon video data in the form of a reconstructed reference block of pixels for use in prediction of a block of pixel values.

27. The method of claim 19, the method being performed as a post-filtering step upon video data after decoding.

28. The method of claim 19, the method being performed as a pre-filtering step upon video data prior to encoding.

29. A computer readable storage medium encoded with instructions which, when loaded and executed by a processing unit, cause the processing unit to carry out the method of claim 19.

30. A control device for sample adaptive offset (SAO) compensation of video data, wherein pixels in the video data are classified into SAO categories, each SAO category representing a possible edge artifact and defining a corresponding offset value to be applied to pixels in the respective SAO category to compensate for the edge artifact, the control device being configured to provide a plurality of SAO categories, the plurality of SAO categories including one or more of the following:
a first SAO category exclusively representing a first edge artifact where a pixel is at least almost equal to one of its neighbors and distinctly lower than the other neighbor in a given spatial direction,
a second SAO category exclusively representing a second edge artifact where the pixel is at least almost equal to said other neighbor and distinctly lower than said one neighbor in the given spatial direction,
a third SAO category exclusively representing a third edge artifact where the pixel is at least almost equal to said one neighbor and distinctly higher than said other neighbor in the given spatial direction,
a fourth SAO category exclusively representing a fourth edge artifact where the pixel is at least almost equal to said other neighbor and distinctly higher than said one neighbor in the given spatial direction, and
a combined SAO category jointly representing either said first and second edge artifacts or said third and fourth edge artifacts in combination, where the pixel is not equal to but close to a first one of the neighbors and distinctly lower or higher than a second one of the neighbors,
wherein the control device is configured to obtain a block of pixels of video data; and
wherein the control device is configured, for pixels in said block of pixels, to evaluate a current pixel with respect to its neighbors for a match with any of the SAO categories in said plurality of SAO categories, and, in case of a match, apply the offset value of the matching SAO category for said current pixel, wherein:
the first SAO category represents the first edge artifact where the pixel is not equal to but close to and higher than said one neighbor and distinctly lower than said other neighbor in the given spatial direction,
the second SAO category represents the second edge artifact where the pixel is not equal to but close to and higher than said other neighbor and distinctly lower than said one neighbor in the given spatial direction,
the third SAO category represents the third edge artifact where the pixel is not equal to but close to and lower than said one neighbor and distinctly higher than said other neighbor in the given spatial direction, and
the fourth SAO category represents the fourth edge artifact where the pixel is not equal to but close to and lower than said other neighbor and distinctly higher than said one neighbor in the given spatial direction.

31. The control device of claim 30, wherein:
the first SAO category exclusively represents the first edge artifact where the pixel is equal to said one neighbor and distinctly lower than said other neighbor in the given spatial direction,
the second SAO category exclusively represents the second edge artifact where the pixel is equal to said other neighbor and distinctly lower than said one neighbor in the given spatial direction,
the third SAO category exclusively represents the third edge artifact where the pixel is equal to said one neighbor and distinctly higher than said other neighbor in the given spatial direction, and
the fourth SAO category exclusively represents the fourth edge artifact where the pixel is equal to said other neighbor and distinctly higher than said one neighbor in the given spatial direction.

32. The control device of claim 31,
wherein the control device is configured to calculate an index as a function edgeIdx=W1*Sign(p(X)−(p(A))+W2*Sign(p(X)−(p(B))+W3, where:
p(X) is a pixel value of the current pixel,
p(A) is a pixel value of one of the neighbors of the current pixel in the given spatial direction,
p(B) is a pixel value of the other neighbor of the current pixel in the given spatial direction, and
W1, W2 and W3 are weight values; and
wherein the control device is configured to use the calculated value of edgeIdx as a pointer in a data structure which defines the respective offset values of the plurality of SAO categories so as to obtain the offset value for the matching SAO category.

33. A video encoder comprising the control device of claim 30.

34. A video decoder comprising the control device of claim 30.

35. A user equipment comprising the control device of claim 30.
